(19) United States
(12) Patent Application Publication
(10) Pub. No.: US 2025/0131626 A1
(43) Pub. Date: Apr. 24, 2025

(54) ELECTRONIC DEVICE, METHOD, AND NON-TRANSITORY COMPUTER-READABLE MEDIUM FOR IMAGE EDITING

(71) Applicant: SAMSUNG ELECTRONICS CO., LTD., Suwon-si (KR)

(72) Inventors: Jihun MUN, Suwon-si (KR); Sungtae KIM, Suwon-si (KR); Jiyoon PARK, Suwon-si (KR); Nagyeom YOO, Suwon-si (KR); Daeyoung HYUN, Suwon-si (KR)

(21) Appl. No.: 18/736,874

(22) Filed: Jun. 7, 2024

Related U.S. Application Data
(63) Continuation of application No. PCT/KR2024/007164, filed on May 27, 2024.

(30) Foreign Application Priority Data
Oct. 24, 2023 (KR) 10-2023-0143245
Jan. 17, 2024 (KR) 10-2024-0007326

(51) Int. Cl. G06T 11/60; G06T 7/50; G06T 11/20

(52) U.S. Cl. CPC G06T 11/60; G06T 7/50; G06T 11/20; G06T 2200/24

(57) ABSTRACT

Electronic devices, methods, and storage mediums for editing images are provided. An image editing method comprises receiving a first user input for a first image. The method comprises determining whether the first user input indicates an instruction to add a first object. The method comprises, when the first user input indicates an instruction to add the first object, generating a first preliminary object image for the first object. The method comprises displaying a second image including the first object, the second image being generated based on the first preliminary object image and being associated with the first image. The method comprises, when a second user input indicates an instruction related to the first object is received for the second image, displaying a third image in which at least one of a size or a location of the first object is changed according to the second user input.

### CROSS-REFERENCE TO RELATED APPLICATIONS

This application is a continuation application of International Application No. PCT/KR2024/007164 designating the United States, filed on May 27, 2024, in the Korean Intellectual Property Office and claiming priority to Korean Patent Application No. 10-2023-0143245, filed on Oct. 24, 2023, and Korean Patent Application No. 10-2024-0007326, filed on Jan. 17, 2024, in the Korean Intellectual Property Office, the disclosures of which are incorporated by reference herein in their entireties.

### TECHNICAL FIELD

Embodiments of the disclosure relate to an electronic device, a method, and a storage medium, for example, an electronic device, a method, and a storage medium for editing an image.

### BACKGROUND ART

An electronic device provides various functions to a user. For example, the electronic device may capture an image and display the captured image. Further, the electronic device may provide a function of editing the image. In general, the electronic device may provide an image editing function for cropping an image or consecutively connecting two images. In addition, the electronic device may provide an image editing function for extracting an object from an image or moving and disposing an object within an image, and an image editing function for adding a new object.

The above information may be provided as related arts for merely helping understanding of the disclosure. Any of the above description cannot be claimed as the prior art related to the disclosure or cannot be used for determining the prior art.

### DISCLOSURE

A method of editing an image according to various embodiments of the disclosure may comprise, for example, receiving a first user input in a first image. The method may identify whether a first user input is an input of adding a first object. When the first user input is the input of adding the first object, the method may request generating a first preliminary object image for the first object. The method may display a second image including the first object generated based on the first preliminary object image, wherein the second image is associated with the first image. When a second user input related to the first object is received in the second image, the method may display a third image in which at least one of a size and a location of the first object is changed according to the second user input, based on the first preliminary object image.

An electronic device according to various embodiments of the disclosure may include a display, at least one processor, and a memory configured to store instructions executed by the at least one processor. The instructions may cause the electronic device to, when a first user input of adding a first object is received in a first image displayed on the display 160, make a request for generating first object image information including a first part and a second part of the first object. The instructions may cause the electronic device to display a second image in which the first part between the first part and the second part of the first object is added to the first image on the display 160, based on the first object image information. The instructions may cause the electronic device to, when a second user input related to the first object is received in the second image, display a third image in which the second part of the first object is added to the second image, based on the first object image information.

A non-transitory computer-readable storage medium recording programs that perform a method of editing an image according to various embodiments of the disclosure may include, when a first touch gesture input is received in a first image through a touch screen, identifying whether the first touch gesture input is an input of adding a first object in the first image or an input of modifying a second object included in the first image. When the first touch gesture input is the input of adding the first object, the non-transitory computer-readable storage medium may include making a request for generating first object image information including a first part and a second part of the first object to an artificial intelligence computing device. The non-transitory computer-readable storage medium may include displaying at least one of the first part and the second part of the first object in the first image, based on the first object image information. When the first gesture input is the input of modifying the second object, the non-transitory computer-readable storage medium may include making a request for generating second object image information including a third part and a fourth part of the second object to the artificial intelligence computing device. The non-transitory computer-readable storage medium may include displaying at least one of the third part and the fourth part of the second object in the first image, based on the second object image information.

### ADVANTAGEOUS EFFECTS

Various embodiments of the disclosure can provide high-level image editing considering a scene or a subject included in an image through an intuitive user input.

Effects of the disclosure are not limited to the above-mentioned effects, and other effects which have not been mentioned above can be clearly understood from the following description by those skilled in the art.

### BRIEF DESCRIPTION OF DRAWINGS

FIG. 1 is a block diagram of an electronic device within a network environment according to various embodiments.

FIG. 2 is a block diagram illustrating a configuration of the electronic device according to various embodiments.

FIG. 3 is a diagram illustrating a process of editing an image according to various embodiments.

FIGS. 4A, 4B, and 4C are diagrams illustrating a process of recognizing an object, based on a drawing element according to various embodiments.

FIG. 5 is a diagram illustrating a process of generating an edited image according to various embodiments.

FIGS. 6A and 6B are diagrams illustrating an example of editing an image according to various embodiments.

FIGS. 7A and 7B are diagrams illustrating an example of analyzing a user input and determining an object according to various embodiments.

FIGS. 8A, 8B, 8C, and 8D are diagrams illustrating an example of moving an object within an image while maintaining reality according to various embodiments.

FIGS. 9A, 9B, and 9C are diagrams illustrating an example of moving an object by using depth information according to various embodiments.

FIGS. 10A, 10B, 10C, 10D, 10E, and 10F are diagrams illustrating an example of adding and moving an object according to various embodiments.

FIGS. 11A, 11B, 11C, 11D, 11E, and 11F are diagrams illustrating an example of adding and moving a plurality of objects according to various embodiments.

FIGS. 12A, 12B, 12C, 12D, 13A, 13B, 13C, and 13D are diagrams illustrating an example of changing shapes of some areas of the object according to various embodiments.

FIGS. 14A, 14B, and 14C are diagrams illustrating an example of adding an object by using other information according to various embodiments.

FIGS. 15A, 15B, 16A, and 16B are diagrams illustrating an example of changing a color of an area within an image according to various embodiments.

FIGS. 17A and 17B are diagrams illustrating an example of editing an image by motion of an electronic device according to various embodiments.

FIGS. 18A, 18B, and 18C are diagrams illustrating an example of displaying an image in various sizes by using a complete object image according to various embodiments.

FIG. 19 is a flowchart illustrating an image editing method according to various embodiments.

Hereinafter, embodiments of the disclosure are described in detail with reference to the drawings to make those skilled in the art to which the disclosure belongs be able to easily realize the disclosure. However, the disclosure may be realized in various different forms and is not limited to embodiments described herein. In connection with description of drawings, the same or similar reference numeral may be used for the same or similar element. Further, in the drawings and description related thereto, description of unknown functions and configurations may be omitted for clarity and briefness.

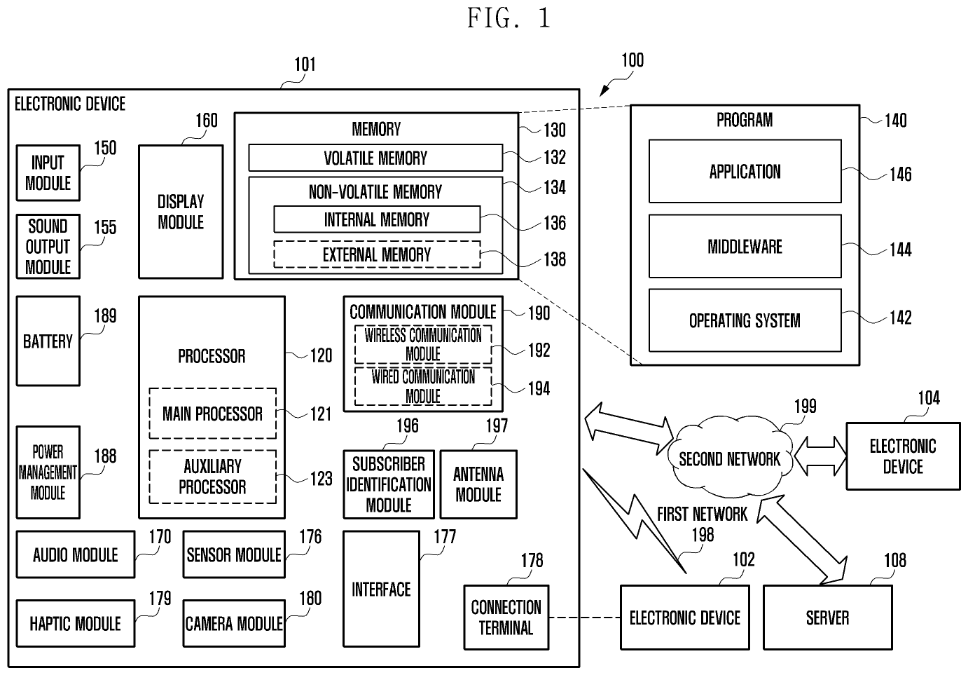

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connection terminal 178, a haptic module 179, a camera module 180, a power management module 188, a battery 189, a communication module 190, a subscriber identification module (SIM) 196, or an antenna module 197. In some embodiments, at least one of the components (e.g., the connection terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The non-volatile memory may include at least one of an internal memory 136 and an external memory 138.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., the electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connection terminal 178 may include a connector via which the electronic device 101 may be physically connected with the external electronic device (e.g., the electronic device 102). According to an embodiment, the connection terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form an mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices (e.g. electronic devices 102 and 104 or the server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

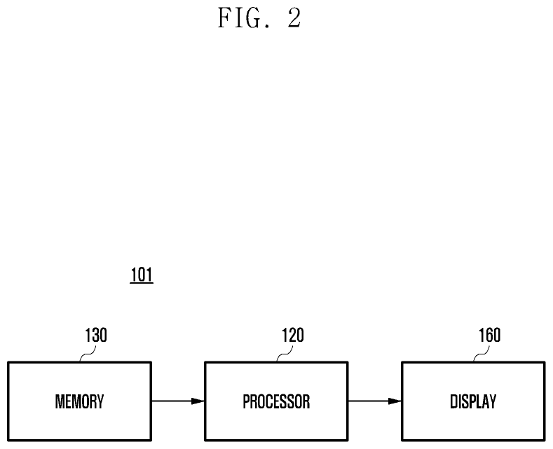

FIG. 2 is a block diagram illustrating a configuration of an electronic device according to various embodiments.

Referring to FIG. 2, the electronic device 101 may include the memory 130, the processor 120, and the display 160.

The memory 130 (for example, the memory 130 of FIG. 1) may store data, algorithms, programs, instructions, and the like that perform functions of the electronic device 101. For example, the memory 130 may store images, image editing algorithms, preliminary object images, and image editing models learned by machine learning or deep learning. For example, the image editing models may include an image analysis model, a user input analysis model, a preliminary object generation model, an atmosphere/lighting model, and/or a depth map generation model. For example, the image editing mode based on artificial intelligence may include a plurality of artificial neural network layers. The artificial neural network may be one of a deep neural network (DNN), a convolutional neural network (CNN), a recurrent neural network (RNN), restricted Boltzmann machine (RBM), a deep belief network (DBN), bidirectional recurrent deep neural network (BRDNN), deep Q-networks, or a combination of two or more thereof, but is not limited thereto. The image editing models based on artificial intelligence may be included in one artificial intelligence computing module included in the electronic device 101 or may be included in different artificial intelligence computing models, respectively. For example, the image editing models based on artificial intelligence may be included in one artificial intelligence computing module included in a separate server (for example, the server 108 of FIG. 1) or may be included in different artificial intelligence computing models, respectively. The image editing models based on artificial intelligence may be logic, firmware, software, and/or hardware modules capable of performing the operation through at least one artificial intelligence computing module.

The processor 120 (for example, the processor 120 of FIG. 1) may control each element of the electronic device 101 by executing instructions and the like stored in the memory 130. The electronic device 101 may include one or more processors 120. For example, the processor 120 may correspond to a plurality of processors that divide a plurality of functions therebetween and perform the functions together.

The processor 120 may display an image (for example, an original image) on the display 160 (for example, the display module 160 of FIG. 1). For example, the image may include a still image (for example, a still image) and a dynamic image (for example, a video). For example, the dynamic image (for example, the video) may be provided in the unit of frames or in the unit of scenes. For example, a frame or a main scene selected from the video may be displayed for image editing, and editing of the corresponding frame or scene may be applied together to another frame or scene related thereto. When a user input is received, the processor 120 may identify the user input. For example, the user input may be an input of adding at least one object to the image displayed on the display, an input of modifying an object, or a control input. In various embodiments of the disclosure, the object may include a thing, a person, and/or a background. For example, the background may be an object such as a sea, a mountain, a sky, or a river behind a thing or a person. For example, the input of adding the object may include an input of adding a new thing and/or person. The input of modifying the object may include an input of changing the size or shape of the object, an input of changing a color, and/or an input of adding a color. The control input may be an input of controlling the object through a method other than drawing of an object shape or adding information on the object. For example, when an arrow is input on the object (or adjacently to the object), the processor 120 may move the object, based on a direction and length of the arrow. For example, when text of log is input on an object having the shape of house (or adjacently to the object), the processor 120 may identify the object as a log cabin. An arrow or text input by the user may be an example of the control input. That is, the processor 120 may identify whether the user input is the input of adding the object, the input of modifying the object, or the control input.

For example, the processor 120 may identify an object which the user desires to add, based on a shape (drawing shape) configured by the user input. For example, the user input may be a touch gesture, and the processor 120 may identify an object which the user desires to add, based on a shape configured by the touch gesture. For example, the user input may be a motion gesture by a user's hand (or finger), the processor 120 may identify an object which the user desires to add, based on a shape configured by the motion gesture. For example, the user input may include an input using a remote controller that can recognize an action in an extended reality (XR) environment or a user gesture recognized through a camera. For example, the user input may be an input distinguished by a touch/non-touch on the display 160 (for example, a touch screen), and the processor 120 may identify the user input according to the existence or non-existence of a touch. For example, when a finger (or an instrument such as an electronic pen) comes in contact with the display 160 and makes a drawing, the processor 120 may identify the user input for adding the object. When a finger (or an electronic pen) hovers and makes a drawing, the processor may identify the user input for modifying the object (for example, for changing texture, changing a color, adding a color, etc.). For example, the user input may be identified as the input for adding the object when the user input is a drawing input on the display 160, and the user input may be identified as the input for modifying the object when the user input is a drawing input through a motion sensor (for example, an acceleration sensor).

According to an embodiment, the user input may be an input using various input devices and/or an input using various input schemes, and the processor 120 may identify the user input, based on the type of input device and/or the input scheme. For example, the processor 120 may identify the user input as the input for adding the object when the user input is a drawing by an electronic pen, and may identify the user input as the input for modifying the object when the user input is a drawing by a finger. For example, the processor 120 may identify the input for adding the object when a drawing is made without pressing of a button of the electronic pen, and may identify the input for modifying the object when the drawing is made in the state where the button of the electronic pen is pressed.

When the user input is identified as the input for adding the object (for example, a first object), the processor 120 may make a request for generating a preliminary object image (for example, a preliminary image of the first object) to an artificial intelligence-based computing device (for example, an artificial intelligence-based computing module or an artificial intelligence-based image editing model). For example, the preliminary object image may be generated not only as just an image but also as image information used for displaying the image of the object. The image information for displaying or generating the object may include, for example, image information that expresses a two-dimensional entire shape of the object, image information that expresses a three-dimensional entire shape of the object, image information that expresses various shapes which may be different depending on angles at which the object is viewed, image information that expresses various shapes which may be different depending on focal distances, and image information that expresses various shapes which may be different depending on view angles. A first preliminary object image may also be generated as first object image information.

For example, the artificial intelligence-based computing device may include an image editing model learned by machine learning or deep learning, and the image editing model may be a generative artificial intelligence model. The generative artificial intelligence model may be a deep learning text-to-image model that receives an input of a prompt and generates an image corresponding to the prompt. For example, the prompt may include various types of content such as text, an image, a web address, and a file. For example, the generative artificial intelligence model may generate an image by using various calculation models such as a generative adversarial network (GAN), a vector quantization GAN (VQ-GAN), a variational auto-encoder (VAE), a VQ-VAE, diffusion, a diffusion-GAN model, and the like.

The GAN model is one of artificial intelligence neural networks using an adversarial neural network structure and may use mock data similar to real data. The GAN model may learn a generator by comparing an image generated by the generator with the original image and evaluating the image by a discriminator. The VAE model is one of probabilistic artificial neural networks, and may encode data with probability distribution in a potential space and perform generation modeling. The VAE model may be a model serving as a generator. The VAE model may extract a feature (for example, eyes, nose, mouth, or the like) that best expresses an input image (X) through an encoder, sample the feature, and generate a latent vector (Z). The VAE model may generate new data most similar to X from Z through a decoder. The VAE model may have the encoder/decoder in comparison with the GAN model, and may learn all of the latent vector, the encoder, and the decoder. The diffusion model may be learned using a forward process (diffusion process) that completely turns data into noise by adding noise from the data little by little and a reverse process that reversely makes data by restoring the data from noise little by little.

For example, the processor 120 may make a request for generating a preliminary object image by loading an image editing model from the memory 130. According to an embodiment, the image editing model may be stored in an external device (for example, the server 108 of FIG. 1). The electronic device 101 may include a communication interface (for example, the communication module 190 of FIG. 1), and the processor 120 may make a request for generating a preliminary object image to the image editing model through the communication interface. That is, the image editing model may be a universal model generally provided by the external device. According to an embodiment, some of the image editing models may be provided by the electronic device 101, or all models may be provided by the electronic device 101 (on-device form).

For example, when the image editing models are generally provided by the external device, the electronic device 101 may transfer an original image selected by the user and user input information to the external device. The external device may identify an added object (including a background) from the user input information. The external device may generate preliminary object images for the identified object and/or the object extracted from the original image and transmit a first edited image which reflects rearrangement of the objects and a lighting characteristic to the electronic device 101. The electronic device 101 may display the received first edited image. When an object within the first edited image is moved by the user, the electronic device 101 may transmit information related to the object of which the location was changed (for example, information of the moved object, coordinate information, or the like) to the external device. The external device may transmit a second edited image which reflects a lighting characteristic and depth information to the electronic device 101, based on the received information. The electronic device 101 may display the second edited image received from the external device.

According to an embodiment, the preliminary object generation model and the depth map generation model may be provided by an external device (for example, the server), and another model (for example, the image analysis model, the user input analysis model, or the atmosphere/lighting mode) may be provided by the electronic device 101. For example, the electronic device 101 may identify an added object from the user input information. Further, the electronic device 101 may analyze the original image and identify information related to an object included in the original image. The electronic device 101 may transmit information on the added object and information on the existing object included in the original image to the external device. The external device may generate preliminary object images for the added object and the existing object, based on the information received from the electronic device 101. Further, the external device may generate a depth map for the added object and the existing object. The external device may transmit the preliminary object images and the depth map information to the electronic device 101. The electronic device 101 may rearrange the objects, based on the depth map information and the preliminary object images and generate the first edited image which reflects the lighting characteristic.

According to an embodiment, all image editing models may be provided by the electronic device 101. When receiving drawing information by a user input, the electronic device 101 may generate a preliminary object image through a preliminary object generation model and generate the first edited image including the generated preliminary object image. The lighting characteristic may be applied to the first edited image. The electronic device 101 may acquire depth information of the first edited image through the depth map generation model. When the electronic device 101 receives an image editing command (for example, object movement) from the user, the electronic device 101 may edit the first edited image according to a user input. When the object moves, the electronic device 101 may update depth information and generate a second edited image which applies the lighting characteristic according to object movement.

The artificial intelligence computing device may identify attributes of a first object (for example, an object configured by a user input), based on a shape configured by the user input. For example, the artificial intelligence computing device may analyze the original image and identify attributes of the first object together with information on the original image. For example, the image information may include information on a scene expressed by the image (for example, a landscape, a building, a person, a food, a city, a country, indoor, outdoor, or the like), time/visual information expressed by the image (for example, sunset, sunrise, night, or the like), imagery reminiscent of the image (for example, comfortable, warm, vibrant, and the like), detailed information on an object (for example, subject) included in the image (for example, a user, a specific person, a user's house, a user's car, and the like), relative sizes of objects included in the image and/or image/object information around a user input. For example, the attributes of the object may include a type, a shape, texture, a color, a characteristic, and/or additional information of the object. As an embodiment, when a user input is a rectangular shape in an indoor image, the artificial intelligence computing device may identify the attributes of the first object as furniture. According to an embodiment, the artificial intelligence computing device may identify the attributes of the object drawn in a human's head part as a hat.

When the artificial intelligence computing device is stored in the memory 130 of the electronic device 101, the artificial intelligence computing device may be loaded to the processor 120 and perform an operation. In this case, the processor 120 may identify attributes of the first object.

The processor 120 (for example, the artificial intelligence computing device) may generate a first preliminary object image of the first object, based on the identified attributes. For example, the first preliminary object image may be an image for the entire shape of the first object. The processor 120 may identify an object from an image including an object having attributes which are the same as or related to the attributes of the identified first object in the image stored in the memory 130 and generate the first preliminary object image. According to an embodiment, the processor 120 may search for a shopping mall site, a portal site, and/or an image of a cloud of a user account through the network. The processor 120 may identify an object from an image including an object having attributes which are the same as or related to the attributes of the identified first object in the found image and generate the first preliminary object image. The processor 120 may generate the first preliminary object image by using the object included in the stored image and/or the found image. According to an embodiment, the processor 120 may generate the first preliminary object image from a user input with reference to the stored image and/or the found image.

The processor 120 may generate a single first preliminary object image or a plurality of first preliminary object images. For example, the plurality of first preliminary object images may be a plurality of images including shapes which can be captured for the first object at different focal distances. For example, the plurality of first preliminary object images may include a plurality of object images including different styles. For example, the processor 120 may generate a preliminary object image for the entire shape of a person including the lower half of the body, based on a drawing of the user describing the upper half of the body of the person. The processor 120 may generate in advance a plurality of first preliminary objects having different clothes, positions, facial expressions, and the like. According to an embodiment, the plurality of first preliminary objects may be images of similar objects that match user input information and belong to the type of the first object. For example, when it is identified that a user input is a red shape and the first object according to the shape of the user input is a hat, the processor 120 may generate a plurality of red hats as first preliminary object images. When the processor 120 generates first preliminary object images of a plurality of similar first objects, the processor 120 may display the generated first preliminary object images of the plurality of similar first objects and determine one first preliminary object according to selection of the user. For example, the first preliminary object images can be used during an image editing process and thus referred to as candidate images, and are generated as images including the entire shape of the object and thus referred to as a complete image.

According to an embodiment, when the background of the original image does not match the attributes of the first object, the processor 120 may insert a new object (for example, another object which is expressed with the first object and may assist the first object or another part of the object) to generate the first preliminary object image. For example, the processor 120 may identify relevance (fitness or consistency) between the attributes of the first object and environment of the image information (or image context). The attributes of the first object may include the type and/or characteristic (feature) of the first object. The environment information of the image may include place information, time information, and/or weather information. The processor 120 may generate a first preliminary image (or information on the first preliminary object image) including a new object related to the first object, based on the relevance. The generated first preliminary object image (or the information on the first preliminary object image) may include an object (or object information) identified from a shape drawn by a user input and a new object (or information on the new object) related to the first object.

As an embodiment, one of the attributes of the background of the image may be indoors, for example a living room, and one of the attributes of the first object may be a tree or a plant. The processor 120 may determine that information on the image background is indoor and the object identified by the user input is a tree. The processor 120 may determine relevance between the place information corresponding to indoor and the attributes of the object corresponding to the tree. The tree planted on an indoor floor may be realistically impossible. For example, the processor 120 may insert a pot which is not input by the user as a new object, based on the determined relevance, and generate a tree planted in the pot as a first preliminary object image.

According to an embodiment, the processor 120 may identify the existing object (for example, the second object) included in the original image and make a request for generating a preliminary image for the existing object (for example, a preliminary image for the second object). When the number of second objects is plural, the processor 120 may select the second object according to a priority. For example, when the number of second objects is a preset number or more and/or when at least one some of the second objects have a size equal to or smaller than a preset size, the processor 120 may select some second objects, based on the priority. Further, the processor 120 may make a request for generating preliminary images only for the selected second objects. For example, the priority may be configured in the order of a person, an animal, home appliances, and furniture. As an example, the priority may be configured in the order of the object size. Since second preliminary object images can be used during an image editing process and thus referred to as candidate images, and are generated as images including the entire shape of the object and thus referred to as complete images.

The preliminary object image according to embodiments of the disclosure may be generated as image information used to display an image for the object as well as being generated as an image. The image information for displaying or generating the object may include, for example, image information that expresses a two-dimensional entire shape of the object, image information that expresses a three-dimensional entire shape of the object, image information that expresses various shapes which may be different depending on angles at which the object is viewed, image information that expresses various shapes which may be different depending on focal distances, and image information that expresses various shapes which may be different depending on view angles. The first preliminary object image or the second preliminary object image may be generated as first object image information or second object image information.

The processor 120 may display a first edited image (for example, an image to which an object is added/altered/removed, in which a color is changed, or to which a color is added) related to the original image, based on the first preliminary object image and/or the second preliminary object image. The first edited image may be an image obtained by calibrating the original image according to an editing input of the user. The first edited image may include the first object and/or the second object. The processor 120 may display a first part and/or a second part of the first object and/or the second object in the first edited image.

The second preliminary object image may include a first part and a second part of the second object. For example, a person in the original image including the upper half of the body of the person may be the second object, and an image of the entire shape of the person (for example, the entire shape including the upper half and the lower half of the body of the person) may be the second preliminary object image. The upper half of the body of the person included in the original image may be the first part of the second object, and the lower half of the body which is not included in the original image may be the second part. Similarly, the first preliminary object image may also include the first part and the second part of the first object. As an example, the processor 120 may generate a first edited image to which the first object identified by a drawing of the user is added. When the processor 120 displays only a portion of the first object is displayed in the first edited image, the part displayed in the first edited image may be the first part (or the second part) of the first object, and the part which is not displayed in the first edited image may be the second part (or the first part). According to an embodiment, the first part and/or the second part of the first object in the first preliminary object image may be displayed according to a displayed display area. According to an embodiment, the first part and/or the second part of the second object in the second preliminary object image may be displayed according to a displayed display area. The processor 120 may display the second object in the first edited image, based on the relationship with the first object. For example, the size of the second object included in the first edited image may be different from the size of the second object included in the original image.

The processor 120 may display (add or assign) a lighting effect according to the location of the first object and/or the second object, based on analysis information of the original image.

When receiving an input related to the first object in the first edited image, the processor 120 may display a second edited image associated with the first edited image, based on the first preliminary object image and/or the second preliminary object image. The second edited image may be an image obtained by calibrating the first edited image according to an editing input of the user. The input related to the first object in the first edited image may be an input of moving the object. For example, the input of moving the object may be an input (for example, a drag input) of moving the object to another location on the screen in the state where the object is selected or a control input. As an example, the control input may be an input in an arrow shape corresponding to a distance and a direction in which the object is to be moved. When receiving the input of moving the first object in the first edited image, the processor 120 may display the second edited image obtained by changing the location of the first object, based on the first preliminary object image. The processor 120 may acquire depth information of the first object, based on the change in the location of the first object, and display the first object, based on the acquired depth information of the first object. Further, the processor 120 may automatically change the location of the second object in the second edited image to a location different from the location of the second object in the first edited image, based on the relationship with the first object.

According to an embodiment, when receiving the input of moving the second object in the first edited image, the processor 120 may display the second edited image obtained by changing the location of the second object, based on the second preliminary object image. The second edited image may be an image obtained by calibrating the first edited image according to an editing image of the user. The processor 120 may acquire depth information of the second object, based on the change in the location of the second object, and display the second object, based on the acquired depth information of the second object. Further, the processor 120 may automatically change the location of the first object in the second edited image to a location different from the location of the first object in the first edited image, based on the relationship with the second object.

For example, when the location of the second object is moved according to the user input, the processor 120 may display the first part and/or the second part of the second object in the second edited image, based on the relationship with the first object. As an example, when the location of the first object is moved according to the user input, the processor 120 may display the first part and/or the second part of the first object in the second edited image, based on the relationship with the second object.

When the location of the first object and/or the second object is changed, the processor 120 may display (and/or assign or change) a lighting effect, based on the change in the location of the first object and/or the second object. As an example, when sunlight is displayed in a center top area of the first edited image and the first object (or the second object) is displayed in a left bottom area, the processor 120 may display a shadow effect of the first object (or the second object) in the first edited image in a left direction. When the location of the first object (or the second object) is changed to a right bottom area according to the user input, the processor 120 may display (or change) a shadow effect of the first object (or the second object) in the second edited image.

The display 170 may output data processed by the processor 120 in the form of an image. The display 170 may display the original image, the first edited image (for example, the image to which the object is added), or the second edited image (for example, the image in which the object is moved). Further, the display 170 may display a user interface (UI) related to an input of adding the object, an input of modifying the object, or a control input. For example, the display 170 is implemented as a touch screen and may receive a user input on the display.

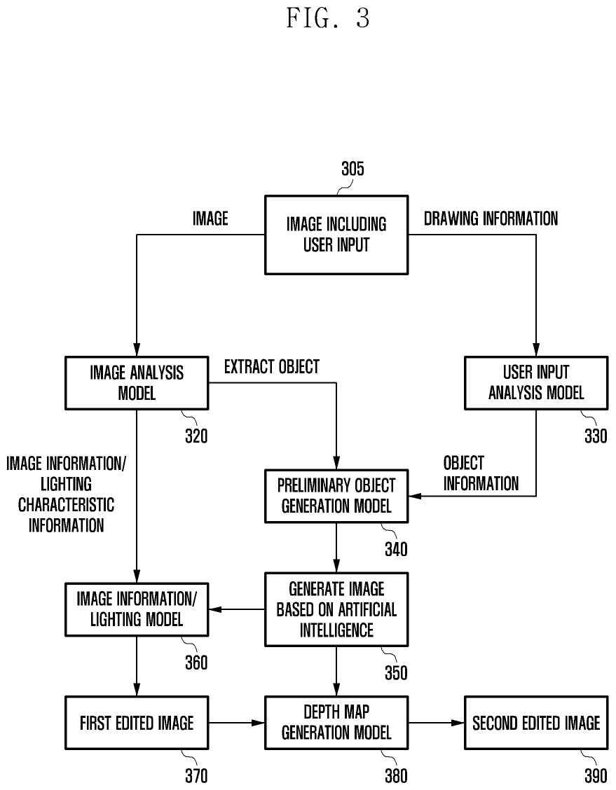

FIG. 3 is a diagram illustrating a process of editing an image according to various embodiments.

Referring to FIG. 3, the electronic device, for example, the electronic device 101 of FIGS. 1-2, may display an image (for example, an original image) and receive a user input in the displayed image. The user input may be an input, for example, including, but not limited to, using a finger, a gesture (or motion), a mouse, a keyboard, a camera, and/or an electronic pen. The electronic device 101 may analyze both an image (image area, image data, or the original image) and drawing information by the user input in an image 305 including the user input (for example, a drawing).

For example, an image analysis model 320 may analyze the image in the image 305 including the user input (for example, a drawing). The image analysis model 320 may analyze information on the image and/or a lighting characteristic. The image analysis model 320 may be an artificial intelligence model learned based on machine learning or deep learning. The image analysis model 320 may generate a prompt (for example, cozy, shining sun light, before sunset, or the like) including the analyzed information on the image and/or the analyzed lighting characteristic (for example, a direction of light). The electronic device 101 may arrange an object added to match the information on the image and/or the lighting environment, based on the prompt generated by the image analysis model 320.

Further, the image analysis model 320 may extract an object (including a background) from the image. For example, the image analysis model 320 may identify an object to be extracted. For example, the processor 120 (e.g., of FIGS. 1-2 above) may display candidates of the object to the user and identify the object to be extracted according to selection of the user. The image analysis model 320 may identify the object in an area irrelevant to a drawing area. Further, the image analysis model 320 may determine a main object according to a preset priority, based on the number, the size, and/or the type of objects. For example, when the object to be extracted is a person, the image analysis model 320 may provide a UI of receiving an input for a style of the person from the user in order to generate a preliminary object image for the person (for example, skirt, pants, slippers, dress shoes, sneakers, or the like). The image analysis model 320 may generate a prompt including the person and the input style information in order to generate the preliminary object image.

A user input analysis model 330 may identify the input drawing. For example, the user input analysis model 330 may identify an object addition input, an input of adding (or changing) a color of the object (for example, background), and/or a control input.

For example, the user input analysis model 330 may determine whether to add the object or add (or change) the color according to whether the drawing is a simple geometrical shape (for example, dot, line, or face) or a shape corresponding to a combination of several figures. The user input analysis model 330 may perform learning related to color addition by using a data set including a simple geometrical image in various colors. When simple geometrical images including colors are grouped according to a preset reference and include a predetermined shape, the grouped simple geometrical images may be recognized as objects. The user input analysis model 330 may perform learning for the object by using a data set including the grouped simple geometrical images.

The user input analysis model 330 may analyze the input drawing and convert the object in the image into a drawing type. The user input analysis model 330 may acquire drawing information through an inverse conversion process of converting the object in the image into the drawing type. The user input analysis model 330 may calibrate the image, based on the acquired drawing information. The user input analysis model 330 may increase the performance by learning the calibrated image again through the added data set.

The user input analysis model 330 may receive information on thickness of a line input through the drawing UI before receiving the user input. For example, the user input analysis model 330 may determine a drawing for the color of the object (for example, the change in the color of the background or addition of the color) when a thick line is selected, and may determine a drawing for object addition when a thin line is selected. According to an example, the user input analysis model 330 may determine whether to add the object and/or change the color, based on a preset drawing pattern.

For example, the user input analysis model 330 may group a plurality of drawing elements, based on the color of the drawing input by the user, the continuity, and the relationship between the input location and an image area, and determine whether to add the object and/or add (or change) the color, based on the grouped drawing elements. For example, the drawing elements may include an individual line configuring parts of the object with the sameness, and a figure or an area including a plurality of lines. The user input analysis model 330 may determine each drawing element according to the color, the continuity, and/or the input location of the input drawing and group a plurality of drawing elements according to the relationship between the input location of each drawing element and the image area. Further, the user input analysis model 330 may determine whether the object is added, the color is added, the color is changed, or there is a control command, based on the grouped drawing elements. As an example, when the input drawing (or a plurality of drawing elements which has been grouped) has a shape of a comb pattern or a zigzag pattern within an object area or draws a boundary of a specific area and then has the same color and repeated form therein, the user input analysis model 330 may identify that the input drawing is the input for adding the color.

According to an embodiment, the user input analysis model 330 may identify the input drawing according to an input tool or an input scheme. For example, when a finger and/or an electronic pen comes into contact with the display 160 (e.g. the display 160 of FIGS. 1-2) and makes a drawing, the user input analysis model 330 may identify the input of adding the object. When a finger and/or an electronic pen hover on a touch screen and makes a drawing, the user input analysis model 330 may identify the input of adding (or changing) the color of the object. According to an embodiment, when the drawing is made in the state where a button of the electronic pen is not pressed, the user input analysis model 330 may identify the input of adding the object. When the drawing is made in the state wherein the button of the electronic pen is pressed, the user input analysis model 330 may identify the input of adding the color of the object. According to an embodiment, the user input analysis model 330 may identify the drawing input on the display 190 as the input of adding the input and identify a drawing input by motion of a user's hand identified through a camera or motion of the electronic device 101 identified through a motion sensor as the input of adding the color.

The user input analysis model 330 may generate information on the object related to the identified drawing as a prompt. For example, the user input analysis model 330 may generate a prompt of generating the object and/or adding color, based on a result of determination for an area of the image in which the drawing is input and a colored area. The prompt including object information generated by the user input analysis model 330 may be input into a preliminary object generation model 340. For example, the prompt may be a textual, visual, and/or sound form. The textual prompt may be a prompt input in a text form. The textual prompt may be a natural language form. The visual prompt may be a prompt in an image form. The visual prompt may be used to generate information in another form in the general image. For example, the visual prompt may be used when depth information is generated in the image (for example, the original image or the first edited image). As an example, a depth map generation model 380 may generate depth information acquired from the image as the visual prompt (for example, a depth map in an image form). For example, the visual prompt may be used when skeleton information for acquiring a shape and/or operation information are acquired from a person image and/or an animal image. As an example, the image analysis model 320 may generate skeleton information of the object as the visual prompt. For example, when the visual prompt is used together with text information, the visual prompt may be used when a converted image is acquired according to input text information. As an example, when the user inputs text of log together with a drawing in a house shape, the preliminary object generation model 350 may acquire a preliminary object image of a log cabin, based on the visual prompt in the house shape generated by the user input analysis model 330 and text. The sound prompt may be a prompt which is similar to the text prompt but is input in the form of a sound (for example, a voice) instead of text. The prompt input in the form of the sound may be converted into text prompt. For example, a model learned according to a specific frequency may output a result of a pre-learned operation when the sound prompt is input.

In various embodiments of the disclosure, the prompt input by the preliminary object generation model 330 may be a prompt having the drawing analysis result converted into the text form and/or a prompt having an input image converted into the visual form. For example, when the user draws a tree on a bottom-right of the input image through a drawing, a prompt in the text form such as “The tree is currently centered on the bottom-right coordinate center pixels 250 (x-coordinate) by 145 (y-coordinate) in the figure” may be input into the preliminary object generation model 340.

The user input analysis model 330 may identify whether the object is additionally input or a color addition/change input is made, identify the relevance with an area within image into which the drawing is input, and identify attributes (for example, the type, the shape, or the like) of the drawing. For example, the prompt may include a sentence (for example, an object of . . . ’, ‘a landscape of . . . ’) describing a background or an object according to thickness of a pen designated by the user. The prompt may include a word describing attributes and a color of the drawing analyzed by the user input analysis model 330.

The user input analysis model 330 may provide a preset pattern to the user and identify attributes of the drawing, based on the preset pattern. For example, the preset pattern may be identifying the type of the object (or attributes of the drawing) or identifying a control command.

As an example, the user input analysis model 330 may identify one vertical line as a tree and identify three or more vertical lines as a forest. One circle and two vertical lines may be identified as a cat, and two overlapping circles and two vertical lines may be identified as a fox. When attributes of the input drawing are identified as a fox, the user input analysis model 330 may generate a prompt for generating a fox image. As an example, the user input analysis model 330 may generate a prompt including information of a natural language such as “Generate an image of a fox expressing emotions in its own unique way.” and input the same into the preliminary object generation model 340.

The user input analysis model 330 may determine whether the identified object matches an area within the image into which the drawing is input (or determine fitness, reality/feasibility, or suitability), based on the relevance therebetween. When the identified object does not match the area into which the drawing is input, the user input analysis model 330 may determine whether a new object is generated. As an example, the user input analysis model 330 may determine that attributes of a user input received in an indoor image is a tree. However, an indoor floor and the tree may not match each other (e.g., do not go together or lack realism). The user input analysis model 330 may determine that a pot is generated as a new object.

For example, the user input analysis model 330 may determine whether the received user input is a control command. When the user input is the control command, the electronic device 101 may perform an operation according to the control command. As an example, the control command may include a command that provides detailed information on the drawing or a command for editing an image.

For example, the electronic device 101 may receive an input of text. The user input analysis model 330 may identify attributes of the drawing by additionally using the input text. As an example, a drawing of a triangle may be input on a rectangle, and text of “log” may be input. The user input analysis model 330 may identify attributes of the drawing corresponding to a house, based on a shape of the drawing and identify attributes of the drawing corresponding to a log cabin which is a lower category of the house, based on the input text.

For example, the control command may include a drawing for editing an image. The electronic device 101 may provide an object movement function as a control command through the drawing. When the user inputs a circle drawing around a drawing in a person shape and a drawing in a left arrow shape into a left area near the circle drawing, the user input analysis model 330 may recognize a control command of moving the person object in the circle drawing in an arrow direction. The processor 120 may generate a preliminary object image for the person through the preliminary object generation model 340 and generate a first edited image by moving the person object to the left when rearranging the object. According to an embodiment, a second edited image in which the object is moved by the control command through the drawing in the first edited image may be generated. For example, types of the control command may be distinguished according to a shape or size of the control drawing. In the above example, a movement distance of the object may be determined according to a length of the arrow. That is, the selected object may be moved by the length of the arrow or may be moved by a preset distance proportional to the length of the arrow.

The processor 120 may extract information required for generating the preliminary object image and generate the preliminary object image through the preliminary object generation model 340 using the extracted information. As an example, the extracted information may include an image stored in the memory 130 of the electronic device 101 and/or a cloud server, a found image, predetermined data, a shopping list, a shopping list image, a list of interest, an image of interest, and/or a screen shot. The preliminary object generation model 340 may receive a prompt (or output data) generated by the image analysis model 320 and/or the user input analysis model 330. According to an embodiment, the preliminary object generation model 340 may receive the extracted information to generate the preliminary object image. The preliminary object generation model 340 may generate the artificial intelligence-based image 350 (for example, the preliminary object image), based on the received image and the received information. When the user input analysis model 330 determines generation of a new object, the preliminary object generation model 340 may generate the preliminary object image including the new object. The electronic device 101 may secure the diversity of preliminary object images which can be generated. The preliminary object generation model 340 may generate the preliminary object image including the entire shape of the object. The object included in the original image and/or the object identified by a user input may be generated in the form of a completed object even though a portion thereof is not displayed on the display 160. The preliminary object image may include, for example, image information that expresses a two-dimensional entire shape of the object, image information that expresses a three-dimensional entire shape of the object, image information that expresses various shapes which may be different depending on angles at which the object is viewed, image information that expresses various shapes which may be different depending on focal distances, and image information that expresses various shapes which may be different depending on view angles. When the image is edited (or the object moves) or a display area of the display changes, the processor 120 may process the image in real time by using the generated preliminary object image and display the processed image.

An image information/lighting model 360 may receive the prompt including image information and/or lighting characteristic information and the generated artificial intelligence-based image 350 (for example, the preliminary object image). The image information/lighting model 360 may arrange the generated preliminary object image to match the original mage and generate a first edited image 370 that reflects the lighting characteristic information to update lighting information.

A depth map generation model 380 may acquire depth information of the object from the first edited image 370 (for example, an image to which the image information and/or the lighting characteristic are applied). For example, the depth information may be perspective-related data according to spatial arrangement of objects. The depth information may include information related to a surface distance of the object included in the image (for example, the first edited image) from a viewpoint of observation. A depth map generation model 380 may be an artificial intelligence model that calculates depth information of the object from an individual image. The depth map generation model 380 may acquire depth information of the object (including the background) within the image. As an example, the depth information may include information acquired using a sensor that obtains depth information such as light detection and ranging (LiDAR) or time of flight (ToF) when the image is captured. The depth information may be stored metadata of the image.

The depth map generation model 380 may store the acquired depth information of each object of the first edited image 370 in the memory 130. When receiving an object movement command from the user, the depth map generation model 380 may update depth information of the moved object, based on a change in the location of the object. The depth map generation model 380 may update the depth information and store the updated depth information in the memory 130.

The processor 120 may generate a second edited image 390, based on the depth information updated according to movement of the object. The processor 120 may change an object display area, based on the state of the object before movement and the changed location information. For example, the processor 120 may display only an area (for example, a first part) of the upper half of the body of the person before movement and display an area (for example, a first part and a second part) of the entire body of the person after movement. The processor 120 may change the lighting characteristic according to movement of the object through the image information/lighting model 360 according to movement of the object. Accordingly, when performing image editing to move the object, the electronic device 101 of the disclosure may use the preliminary object image and thus may not additionally use the image generation mode and may edit the image in real time. Further, the electronic device 101 may update depth information of the object included in the image according to the change in the location of the object, thereby editing the image while continuously preserving perspective.

The division, the use, the connection relation, the operation order, and the like of the image analysis model 320, the user input analysis model 330, the preliminary object generation model 340, the image information/lighting model 360, and the depth map generation model 380 presented as examples of the disclosure can be variously modified. In the above example, the process of generating the first edited image 370 to which the preliminary object image is applied through the image information/lighting model 360 and generating the second edited image 390 through the depth map generation model 380, based on the generated first edited image 370 is presented, but embodiments of the disclosure are not limited thereto. For example, the image information and the lighting-related information acquired through the image information/lighting model 360, the preliminary object image acquired through the preliminary object generation model 340, and the depth map information (for example, perspective-related data according to spatial arrangement of objects) acquired through the depth map generation model 380 may be processed by at least one artificial intelligence computing model and generated as the edited image (for example, the first edited image 370). According to an embodiment, the electronic device 101 may separately generate the preliminary object image through the preliminary object generation model 340 in parallel or sequentially while generating the first edited image 370 that expresses an object in a shape drawn by the user through the image analysis model 320 and the user input analysis model 330, and then use the preliminary object image during a process of generating the second edited image 390 later.

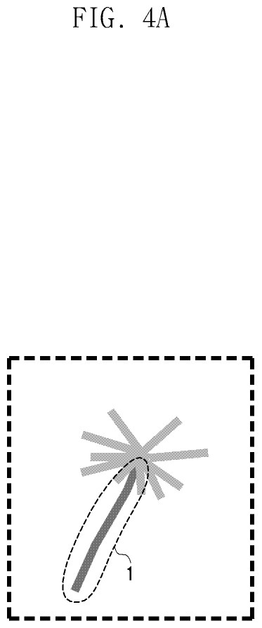

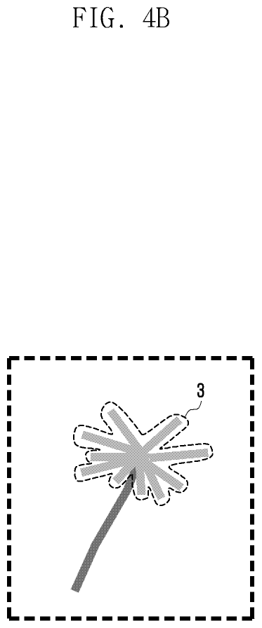

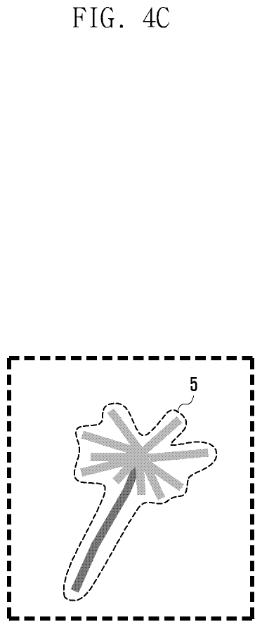

FIGS. 4A, 4B, and 4C are diagrams illustrating a process of recognizing an object, based on drawing elements according to various embodiments.

Referring to FIG. 4A, the electronic device 101 (e.g., the electronic device 101 in FIGS. 1-2) may determine drawing elements according to continuity based on an input time point. For example, the drawing elements may include an individual line configuring a part of the object with the sameness or consistency and a figure or an area including a plurality of lines. The electronic device 101 may determine each drawing element according to a color, a location, and continuity of the input drawing. As an example, the electronic device 101 may receive an input of one line in a first color. One line may be actually input seamlessly. The electronic device 101 may determine one continuously input as a first drawing element 1.

Referring to FIG. 4B, the electronic device 101 may determine drawing elements based on the same color. For example, the electronic device 101 may receive an input of a plurality of second lines in a second color. The plurality of second lines are individual lines but may be input in the same color adjacently to a location at which parts thereof overlap. The electronic device 101 may determine the plurality of second lines input to the adjacent location in the same color as second drawing elements 3.

Referring to FIG. 4C, the electronic device 101 (or an artificial intelligence-based image editing model) may group a plurality of drawing elements. For example, the electronic device 101 may group a plurality of drawing elements, based on at least one of proximity of the location between drawing elements, the relevance, the continuity based on an input time point, and the relevance between the input location and the original image area. For example, the first drawing element 1 and the second drawing element 3 may be input at adjacent locations at a very short time interval and may include the relevance therebetween. The electronic device 101 may determine the first drawing element 1 and the second drawing element 3 as a group 5 of the grouped drawing elements. The electronic device 101 may determine whether there is a control command of adding the object, adding the color, or changing the color or attributes of the object, based on the group 5 of drawing elements.

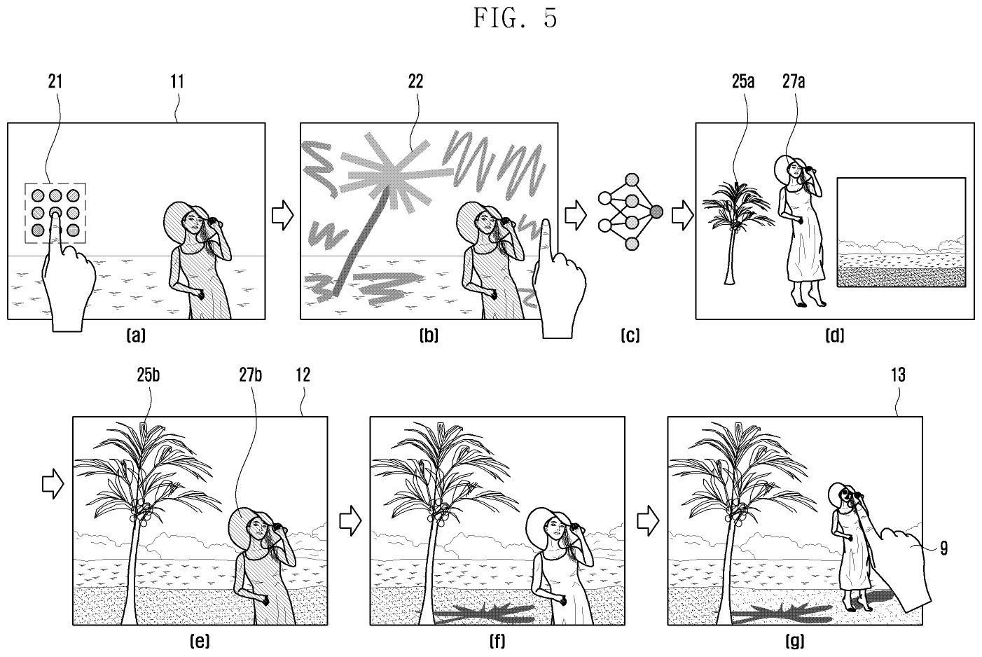

FIG. 5 is a diagram illustrating a process of generating an edited image according to various embodiments.

Referring to FIG. 5A, the electronic device 101 may display an image 11 (for example, the original image) and receive a user input in the displayed image. The user input may be an input using a finger, a gesture (or motion), and/or an electronic pen. As an example, the electronic device 101 may display a UI 21 for selecting a color.

Referring to FIG. 5B, the electronic device 101 may receive a user input in the selected color in the displayed image and, referring to FIG. 5C, identify a drawing input 22 configured by a user input using an image editing model (for example, a user input analysis model).

For example, the electronic device 101 may determine the continuity based on an input time point, a color of the drawing, and/or a drawing element according to an input location. For example, the drawing element may include an individual line configuring a part of the object with the sameness and a figure or an area including a plurality of lines. The electronic device 101 may group a plurality of drawing elements, based on the relationship between the input location of the drawing element and an image area. Further, the electronic device 101 may determine whether the object is added, the color is added, the color is changed, or there is a control command, based on the grouped drawing elements. When the user input (or the drawing input) is determined as an input of adding the object, the electronic device 101 may identify the object, based on a shape drawn by the user input.

As an example, when the screen is small or an area in which the user is to be drawn is small, the electronic device 101 may enlarge the image according to an input of an enlargement gesture (for example, a zoom gesture). The electronic device 101 may analyze the relevance of drawing elements, based on the input drawing elements and automatically group the drawing elements. The electronic device 101 may provide a UE for displaying the grouped drawing elements or modifying the grouped drawing elements. Further, the electronic device 101 may adjust the size and the location of the input drawing and arrange the drawing group at the location intended by the user.

As an example, the electronic device 101 may determine whether the color of the drawing in a background area is brighter or darker than the color of the background and provide a UI for selecting a time/visual option (for example, a.m./p.m., morning/afternoon/evening, sunset time, or the like) and/or a weather option expressed by the image to the user.

The electronic device 101 may generate a prompt for changing the time/visual information expressed by the image, based on a capturing time extracted from metadata of the image. For example, when the capturing time of the image is 12 p.m. and a colored drawing in blue is input into a sky area, the electronic device 101 may generate a prompt for generating clear sky on a bright day. As another example, when the capturing time of the image is 5 p.m. and a colored drawing in blue is input into a sky area, the electronic device 101 may generate a prompt for generating clear sky in the evening.

In parallel or continuously, the electronic device 101 may extract the object (including the background) by using an image editing model (for example, an image analysis model) and analyze information on the image and/or a lighting characteristic. For example, the information on the image may include information on a scene of the image, time/visual information, imagery reminiscent of the image, detailed information related to an object included in the image, relative sizes of objects, and/or image/object information around a user input. The lighting characteristic may include information on the type, the direction, the intensity, the angle, and/or the range of light.

Referring to FIG. 5D, the electronic device 101 may generate preliminary object images 25a and 27a for the object by using an image editing model (for example, a preliminary object generation model). For example, the preliminary object images 25a and 27a may include a preliminary object image for an object determined based on a shape of the drawing and/or an object included in the image. For example, the object included in the image may be an object (for example, a person, a main object, or the like) included in the original image rather than that by the drawing input 22. The electronic device 101 may generate the preliminary object images 25a and 27a including the entire shape of the object. For example, the electronic device 101 may generate the preliminary object images 25a and 27a in the completed shape for the object determined from the shape of the drawing input 22. As an example, the electronic device 101 may extract the object (or information on the object) included in the original image 11 rather than the drawing input 22 and generate the preliminary object images 25a and 27a in the completed shape for the extracted object (or information on the object). The preliminary object images 25a and 27a of the object included in the original image 11 and/or the object identified by the user may be generated in the completed object shaped regardless of whether they are displayed on the display 160.

For example, the preliminary object images 25a and 27a may include image information that expresses a two-dimensional entire shape of the object, image information that expresses a three-dimensional entire shape of the object, image information that expresses various shapes which may be different depending on angles at which the object is viewed, image information that expresses various shapes which may be different depending on focal distances, and image information that expresses various shapes which may be different depending on view angles. When the image is edited (for example, the object moves) or a display area of the display 160 changes, the electronic device 101 may process the image in real time by using the generated preliminary object image and display the processed image.

As an example, the electronic device 101 may identify an object which the user desires to add based on an input drawing shape and information on the identified image. The electronic device 101 may generate a single preliminary object image or a plurality of preliminary object images for the identified object. Further, the electronic device 101 may provide a UI for selecting one object image from the plurality of preliminary object images. When one preliminary object image is selected, the electronic device 101 may generate a first edited image 12 to which an object 25b is added based on a selected preliminary object image 25a.

As an example, the electronic device 101 may extract the object (acquire information on the object type, the object appearance, or the like) from another relevant image by using metadata of the image (for example, information such as date/time/location or the like). For example, the electronic device 101 may identify a place in which the image is captured from the metadata. The electronic device 101 may search for and extract an object which is the same type of the identified object from another image captured in a place that is the same as or adjacent to the identified capturing place. As another example, the electronic device 101 may search for an image including the same or similar information for the place or the object through crawling (or web search) using a keyword related to the identified capturing place and information on the identified object and acquire information on the object which the user desires to add. For example, the electronic device 101 may identify a time at which the image is captured in the metadata. The electronic device 101 may search for and extract an object which is the same type of the identified object from another image captured at a time point similar to the identified time.

As another example, the electronic device 101 may search for and extract (for example, information on the object type, the object appearance, or the like) the object which is the same type as the identified object from another image, based on information on the existing object included in the image (for example, the original image). As an example, the electronic device 101 may receive an input of a drawing on a face of a specific person included in the image. The electronic device 101 may identify sunglasses as the object (or the object type), based on a shape of the input drawing. The electronic device 101 may search for another image in which a specific person is wearing sunglasses. The electronic device 101 may generate a preliminary object image, based on information on the sunglass image included in the found image.

The electronic device 101 may generate one preliminary object image, based on image information of one object among the extracted objects. According to an embodiment, the electronic device 101 may generate a plurality of preliminary object images, based on image information of a plurality of extracted objects. The electronic device 101 may display the plurality of preliminary object images and generate a first edited image to which the object is added based on one preliminary object image according to selection of the user.

As an example, when there is an object of a specific type which the user previously drawn, the electronic device 101 may preferentially consider the object to be of the specific type previously drawn. For example, when the user adds an existing cat to a sofa as a new object, the electronic device 101 may preferentially determine a cat during a process of determining the type of an animal on the sofa drawn in another image. As an example, when the user makes a drawing of adding one object to the image, the electronic device 101 may propose addition of another object in consideration of image information. For example, when the user draws an umbrella in the image, the electronic device 101 may propose addition of cloud and raindrop or automatically add the same.

Referring to FIG. 5E, the electronic device 101 may arrange the objects 25a and 27a generated based on the preliminary object images 25a and 27a generated using the image editing model (for example, the image information/lighting model) to match the original image 11 and generate the first edited image 12 which reflects information on the lighting characteristic to update the lighting information as illustrated in FIG. 5F.

As an example, when the first edited image 12 is generated from the original image 11, the electronic device 101 may apply a similar (or consistent) editing result to other images captured in a time and/or place similar to the original image 11. For example, when a palm tree is added next to the user in the original image, the electronic device 101 may generally reflect the editing result to other images captured in the place that is the same as the capturing place of the original image 11. When the location of the person moves in the original image 11, the electronic device 101 may generally reflect the editing result to other images captured in the place that is the same as the capturing place of the original image 11. For example, the electronic device 101 may provide a UI for performing automatic batch editing. The electronic device 101 may reflect the editing result in a plurality of selected images. As an example, when an image edited by the user and another image are selected together, the electronic device 101 may provide a UI for asking about whether to apply the editing result of the edited image to another image. For example, the editing result (for example, a shape of the added object) reflected in another image may be adjusted using a preliminary object image pre-generated based on a distance between the object to be added and another object (included in another image, the type of another object, the size of another object, and the like. For example, the electronic device 101 may adjust the size, the sight, and/or the position of another object included in the original image 11, based on the relationship with the newly added object. For example, when a puppy is drawn next to the person included in the original image 11, the electronic device 101 may automatically adjust the size, the sight, and/or the position of the person and/or the puppy in order to make the person look at the puppy by using the preliminary object image of the person.

The electronic device 101 may acquire depth information of the object from the first edited image 12 (for example, the image to which the image information and/or the lighting characteristic are applied) by using the image editing model (for example, the depth map generation model). For example, the depth information may be perspective-related data according to spatial arrangement of objects. The electronic device 101 may store depth information of each object in the acquired first edited image 12 in the memory 130.

Referring to FIG. 5G, the electronic device 101 may receive an object movement command from a user 9. When the object movement command is received from the user 9, the electronic device 101 may change the location of the object 27b (e.g. object 27b of FIG. 5E) according to the user command and update depth information of the moved object 27b, based on the change in the location of the object 27b. As an example, as illustrated in FIG. 5G, the electronic device 101 may move the object 27b of the person to a location farther than the location of the object 27b of the person included in the image of FIG. 5F according to the object movement command of the user 9. The object 27b of the person of which only a potion (for example, a first part) is displayed in the image of FIG. 5F according to location movement may be displayed in the entire shape in the image of FIG. 5G. For example, the electronic device 101 may display the entire shape of the object 27b of the person by using the preliminary object image 27a.

The electronic device 101 may generate the second edited image 13, based on the updated depth information. Further, the electronic device 101 may change a lighting characteristic according to object movement by using the image editing model (for example, the image information/lighting model).

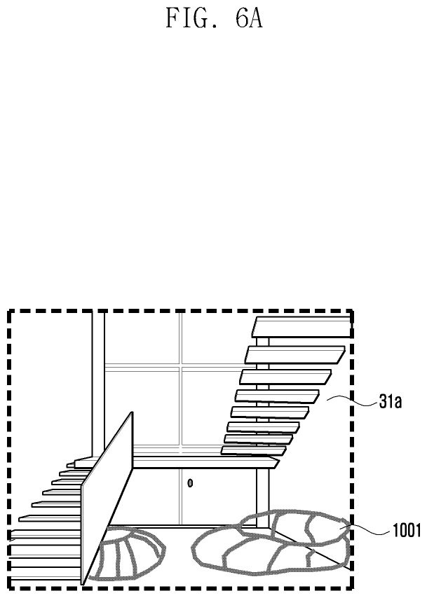

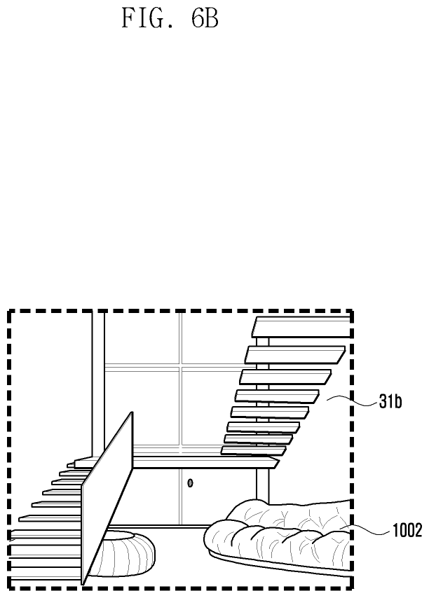

FIGS. 6A and 6B are diagrams illustrating an example of editing an image according to various embodiments.

Referring to FIG. 6A, a drawing in which a drawing element 1001 is added to an original image 31a by a user input is illustrated. The electronic device 101 may identify whether the user input is an input of adding an object. When the user input is identified as the input of adding the object, the electronic device 101 may identify attributes of the drawing 1001 and identify information on the original image 31a and/or the lighting characteristic. The electronic device 101 may generate a prompt for adding the object, based on the identified attributes of the drawing 1001 and the information on the image 31a and/or the lighting characteristic. As an example, the generated prompt may include information of “Generate light blue sofa in the style of avant-garde design”.

Referring to FIG. 6B, an edited image 31b (for example, the first edited image) including an added object 1002 is illustrated. The electronic device 101 may generate an object image (for example, a preliminary object image) by using a preliminary object generation model, based on the generated prompt. The generated preliminary object image may be an image including the entire shape of the object. The electronic device 101 may generate the edited image 31b including the object generated based on the preliminary object image. For example, the edited image 31b including the added object 1002 may be generated using a portion of the preliminary object image. When an additional editing request such as movement of the added object 1002 or insertion of another object is received, the electronic device 101 may display a changed shape of the added object 1002 by using the preliminary object image.

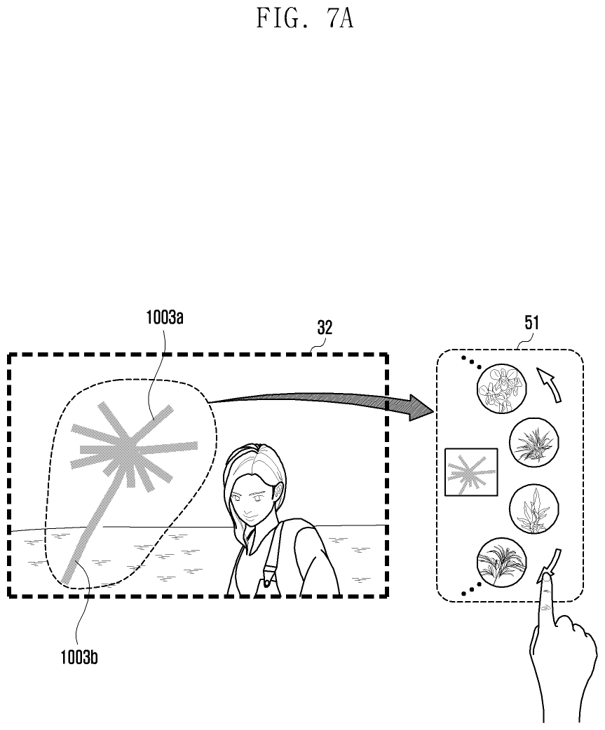

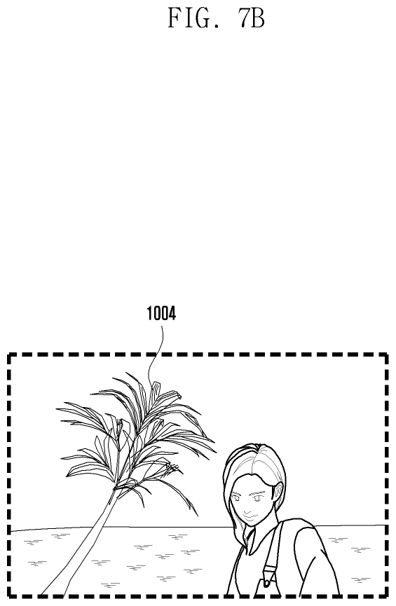

FIGS. 7A and 7B are diagrams illustrating an example of determining an object by analyzing a user input according to various embodiments.

Referring to FIG. 7A, an image 32 including a user input is illustrated. As an example, the user may input drawing elements 1003a and 1003b through a touch or motion. The user may select a specific color and input the desired drawing elements 1003a and 1003b. As an example, the user may input the drawing elements 1003a and 1003b corresponding to a preset pattern. The electronic device 101 may display the drawing elements 1003a and 1003b in the image 32 according to the user input.

The electronic device 101 may identify the user input, based on a shape configured by the user input. The processor 120 may group a plurality of user inputs according to a predetermined reference and identify the user input. For example, the predetermined reference may include a color, proximity of an input location, continuity based on an input time point, and relevance between the input location and an original image area. In FIG. 7A, the first drawing element 1003a may be one drawing element including a plurality of lines input at adjacent locations in the same color and of which portions overlap each other. Further, the second drawing element 1003b may be a drawing element including one line continuously input. The first drawing element 1003a and the second drawing element 1003b may be input at adjacent locations at a very short time interval and may include relevance therebetween. The electronic device 101 may group the first drawing element 1003a and the second drawing element 1003b and determine the user input. Since the grouped drawing elements 1003a and 1003b are not identical to preset control drawing elements and include a predetermined shape, the electronic device 101 may determine an object identified based on the grouped drawing elements 1003a and 1003b as the input of adding the object.

The electronic device 101 may identify information on the image 32, a lighting characteristic, and/or an object. Further, the electronic device 101 may identify attributes of the drawn object, based on the identified image 32, an object included in the image 32, and shapes of the input drawing elements 1003a and 1003b. As an example, the image 32 includes a sea, and the information on the image 32 is a beach, summer, recreation, travel, or the like), and the drawing elements 1003a and 1003b may be determined as a tree shape. For example, the electronic device 101 may identify attributes of the object (for example, the object type, the characteristic, or additional information) as a tree on the beach, a tree in a tropical area, a palm tree, or the like. The electronic device 101 may generate a preliminary object image for the identified object. The electronic device 101 may extract an object from the image including an object related to the identified object from the stored image and/or the found image and generate a preliminary object image. As an example, the electronic device 101 may generate a preliminary object image in various shapes, based on attributes of the identified object. The object image may be generated in the entire shape of the object in consideration of a future image editing process. Accordingly, the generated object image may be referred to as a complete object image. The electronic device 101 may provide a plurality of generated preliminary object images through a UI 51. For example, the preliminary object image may be referred to as preliminary image information or candidate image information.

Referring to FIG. 7B, an image including at least a portion of a generated preliminary object image 1004 is illustrated. The user may select one preliminary object image from a UI 51 including samples (for example, thumbnails) of a plurality of preliminary object images. The electronic device 101 may arrange the selected preliminary object image 1004 in a drawing area of the image 32. Further, the electronic device 101 may reflect the identified lighting characteristic in the preliminary object image 1004 to generate an edited image. In addition, the electronic device 101 may identify depth information for a main object in the image including an added object and store the identified depth information.

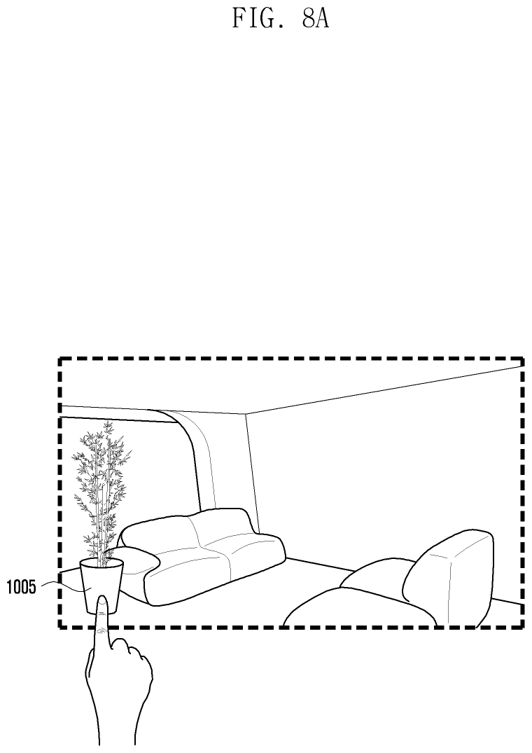

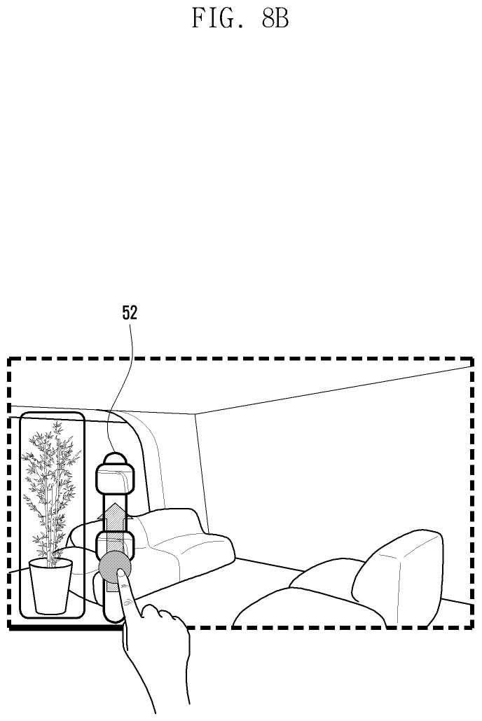

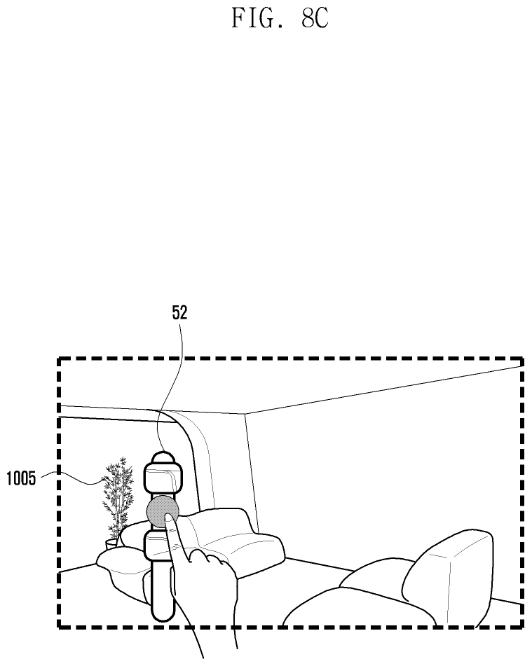

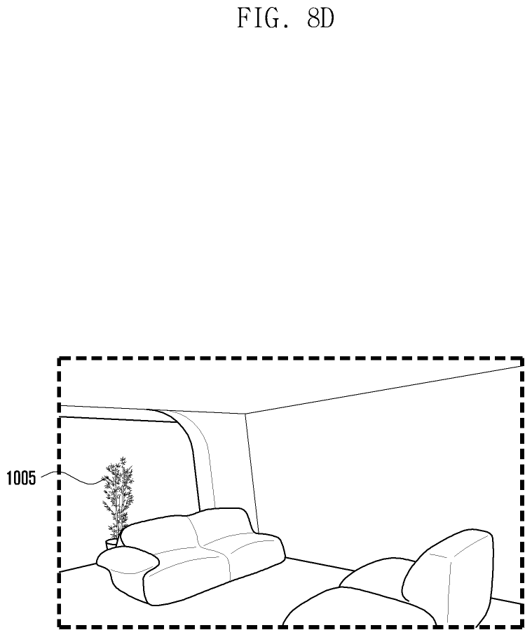

FIGS. 8A, 8B, 8C, and 8D are diagrams illustrating an example of moving an object within an image while maintaining reality according to various embodiments.

Referring to FIG. 8A, an image (for example, a first edited image) to which the object is added is illustrated. The user may move the object within the image. When the object within the image moves, the electronic device 101 may change the size and the location of the object by using the depth information to edit the object to match the image. As an example, an object of a plant 1005 within the image may be selected by the user. According to an embodiment, the electronic device 101 may express a lighting effect varying depending on the location and/or the size of the object, based on lighting characteristic information of the image. For example, the change in the lighting effect may include the intensity or direction of natural lighting or indoor lighting, a change in hue, saturation, brightness, or texture of the object surface considering an effect of another object, or a change in shadow.

Referring to FIG. 8B, according to selection of the plant 1005 corresponding to one of the objects within the image, the electronic device 101 may display a scroll bar receiving an input of location movement of the plant 1005. The electronic device 101 may change the location of the selected plant 1005 in accordance with a user input through the scroll bar 52. According to an embodiment, the electronic device 101 may acquire or update depth information in real time (or periodically) in order to maintain hiding and perspective between the objects. The electronic device 101 may determine whether objects are hidden by each other, based on locations and depth information of the objects.

Referring to FIG. 8C, the electronic device 101 may update depth information in accordance with a user input through the scroll bar 52 and change in real time (or periodically) the location of the plant 1005, a part of the plant to be displayed, a part of the plant to be hidden, and the size thereof, based on the updated depth information.

Referring to FIG. 8D, when the user removes a touch from the scroll bar 52, the electronic device 101 may identify the location and the size of the plant 1005 while the touch is removed as the final location and size. The electronic device 101 may change the lighting effect within the image, based on the final location and size of the plant 1005 and the identified lighting characteristic information. The electronic device 101 may assign a lighting effect corresponding to the change in the location and the size of the plant 1005 to generate an edited image (for example, a second edited image in which the location of the plant is edited).

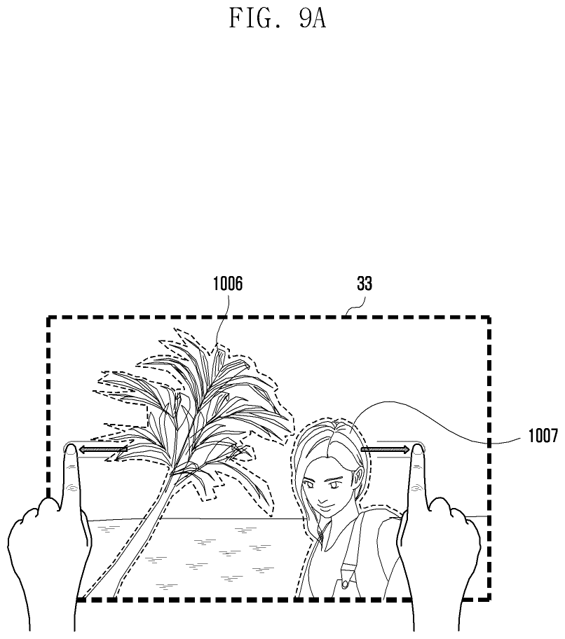

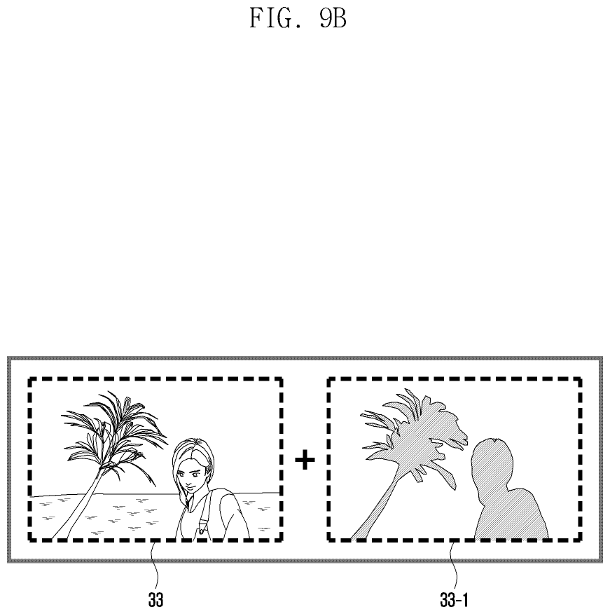

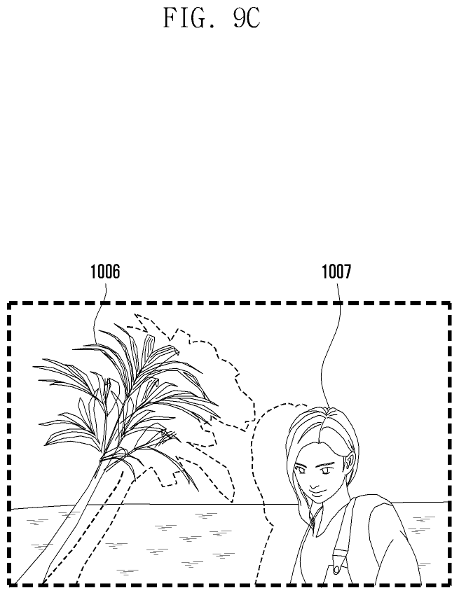

FIGS. 9A, 9B, and 9C are diagrams illustrating an example of moving an object by using depth information according to various embodiments.

Referring to FIG. 9A, a beach image 33 including an object of a tree 1006 and an object of a person 1007 is illustrated. The user may touch the tree 1006 and the person 1007 and move the them in opposite directions.

Referring to FIG. 9B, the electronic device 101 may change locations of the tree 1006 and the person 1007 by using both the image 33 and depth information 33-1. The electronic device 101 may update the depth information 33-1 in order to maintain the relationship and perspective between the objects. Further, the electronic device 101 may identify lighting characteristic information of the image 33.

Referring to FIG. 9C, when the user removes the touch from the tree 1006 and the person 1007, the electronic device 101 may identify the locations and sizes of the tree 1006 and the person 1007 while the touch is removed as the final locations and sizes. The electronic device 101 may change a lighting effect within the image, based on the final locations and sizes of the tree 1006 and 1007, and the identified lighting characteristic information. The electronic device 101 may assign a lighting effect corresponding to the change in the locations and the sizes of the tree 1006 and the person 1007 to generate an edited image (for example, a second edited image) in which the object moves.

As an example, after editing and generating the image, the electronic device 101 may provide a short cut reality function of generating gif data that makes the user see motion of the object for a predetermined time, based on the original image or the edited image. In order to make the recognized object naturally move, the image generation model may learn a direction vector in advance.

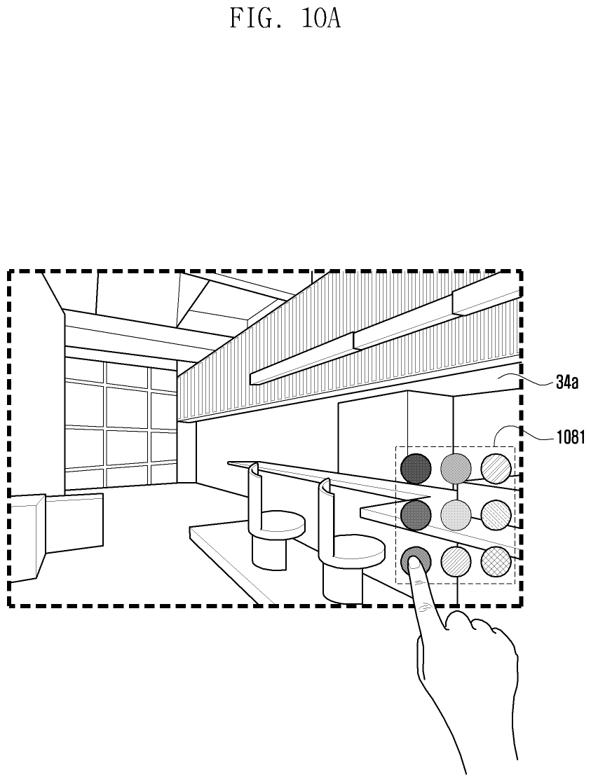

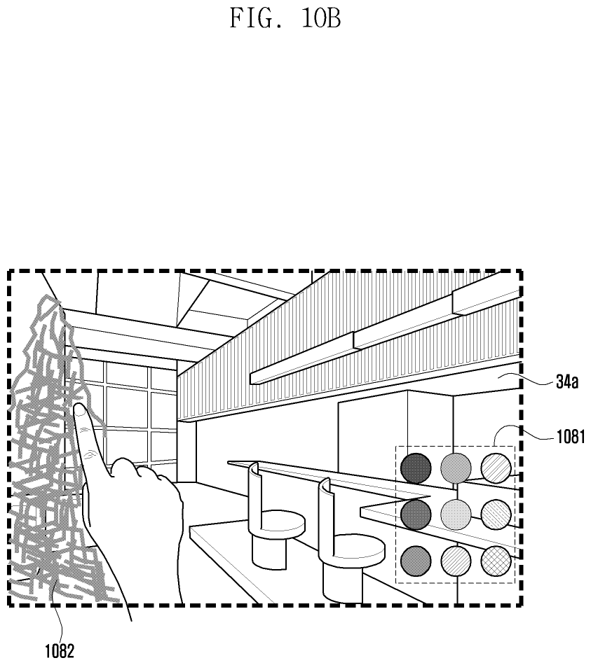

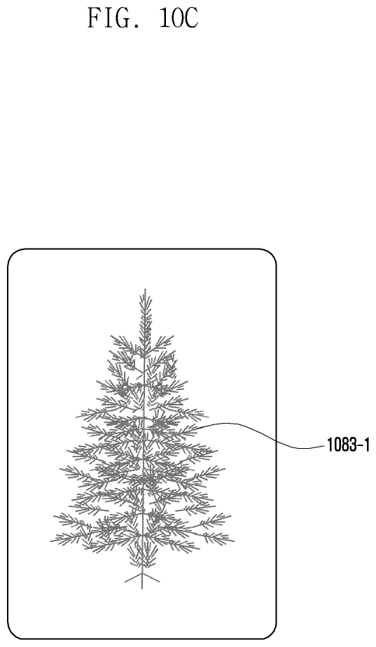

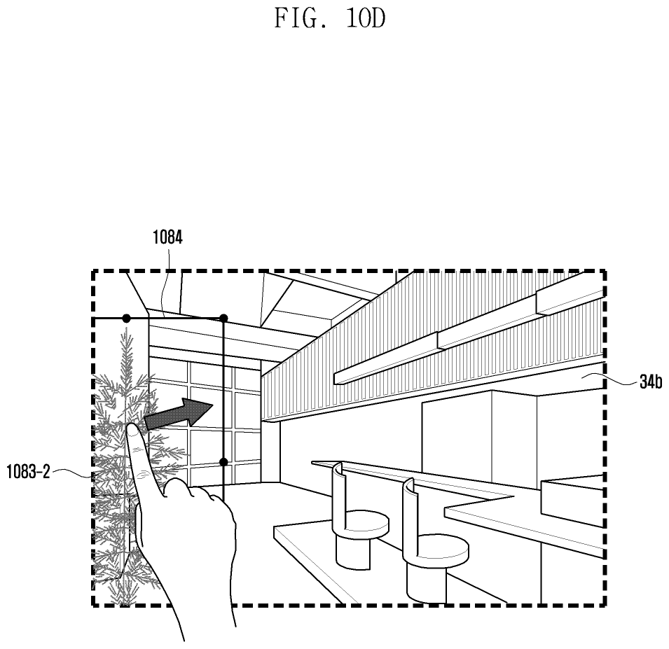

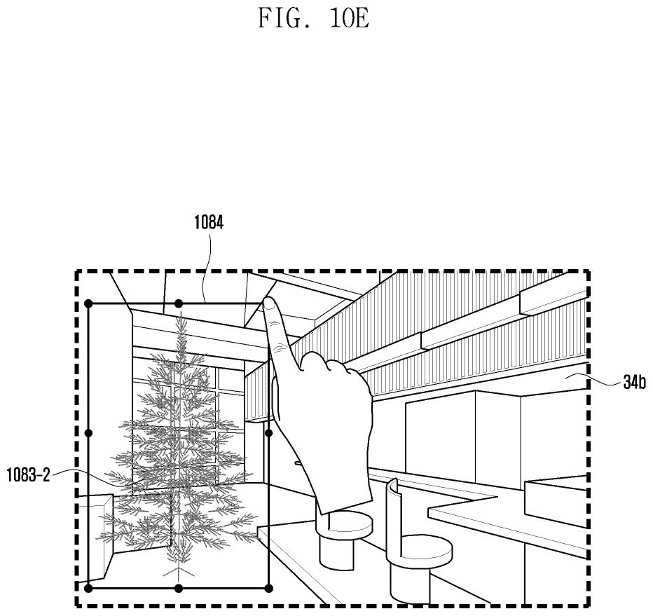

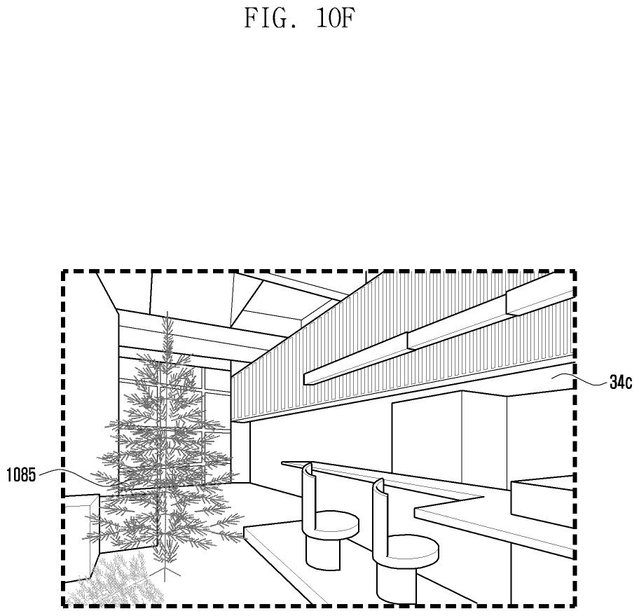

FIGS. 10A, 10B, 10C, 10D, 10E, and 10F are diagrams illustrating an example of adding and moving an object according to various embodiments.

Referring to FIG. 10A, the electronic device 101 may display an image 34a (for example, the original image) and receive a user input in the displayed image 34a. As an example, the electronic device 101 may display a UI 1081 for selecting a color.

Referring to FIG. 10B, the electronic device 101 may receive an input of a drawing in the image 34a. The electronic device 101 may determine a drawing element according to continuity based on an input time point, a color of the drawing, and/or an input location. When it is determined that the drawing element is an input for adding the object, the electronic device 101 may identify the object which the user desires to add based on a shape of the input drawing and information on the identified image. As an example, when receiving an input of a green drawing element 1082 of which an entire shape is a triangle in an indoor image, the electronic device 101 may determine the input drawing element 1082 as an object of a tree or a Christmas tree.

Referring to FIG. 10C, the electronic device 101 may generate a preliminary object image 1083-1 for the object. The electronic device 101 may generate the preliminary object image 1083-1 including the entire shape of the object. The object identified by a user input may be generated in a completed object shape regardless of the shape displayed on the display 160.

Referring to FIG. 10D, the electronic device 101 may arrange an object 1083-2 generated based on the generated preliminary object image 1083-1 to match other objects in the original image 34a and reflect lighting characteristic information to generate a first edited image 34b. As an example, only a portion of the object 1083-2 added to the first edited image 34b, rather than the entire shape thereof, may be displayed according to the location in the image 34d. The electronic device 101 may acquire depth information of the added object 1083-2 from the first edited image 34b.

The electronic device 101 may receive an object selection command from the user. For example, when receiving the object selection command from the user, the electronic device 101 may display an indicator 1084 of displaying an area of the selected object 1083-2.

Referring to FIG. 10E, the electronic device 101 may receive a command of moving the selected object 1083-2. The electronic device 101 may change the location of the object 1083-2 including the indicator 1084 according to a user command and update depth information of the moved object 1083-2, based on the change in the location of the object 1083-2. As an example, the user may adjust the size of the object 1083-2 through the indicator 1084. The electronic device 101 may update depth information of the object 1083-2, based on the changed location and/or size.

Referring to FIG. 10F, the electronic device 101 may generate a second edited image 34c including an object 1085 of which the location has moved. According to an embodiment, the electronic device 101 may generate the second edited image 34c by using the updated depth information. The electronic device 101 may display an entire shape 1085 of the object according to the moved location of the object. The electronic device 101 may display the entire shape 1085 of the moved object by using the generated preliminary object image 1083. According to an embodiment, the electronic device 101 may change a lighting characteristic according to movement of the object 1085.

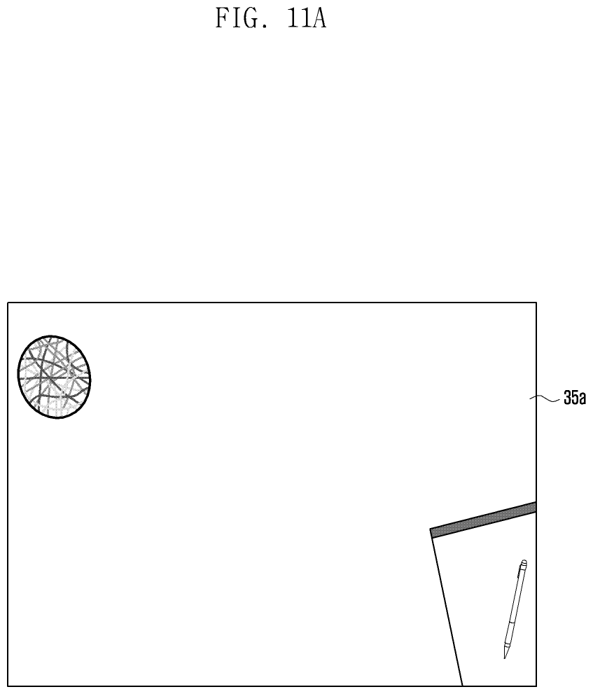

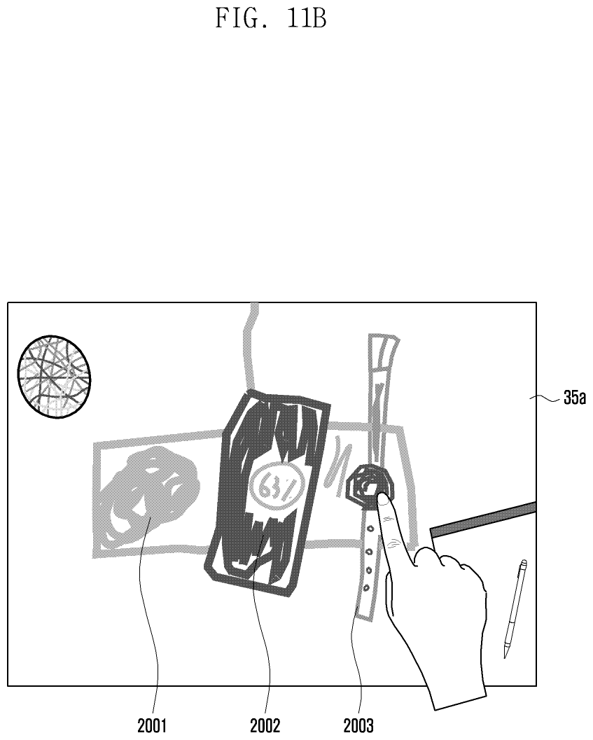

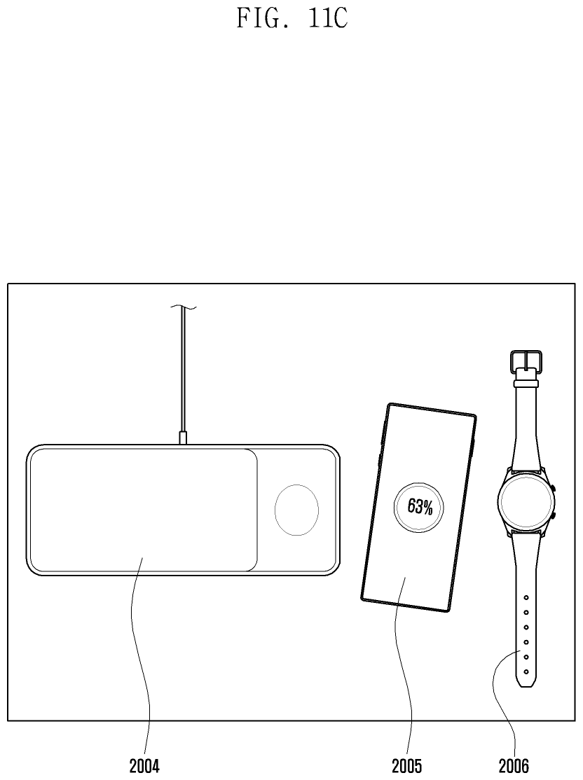

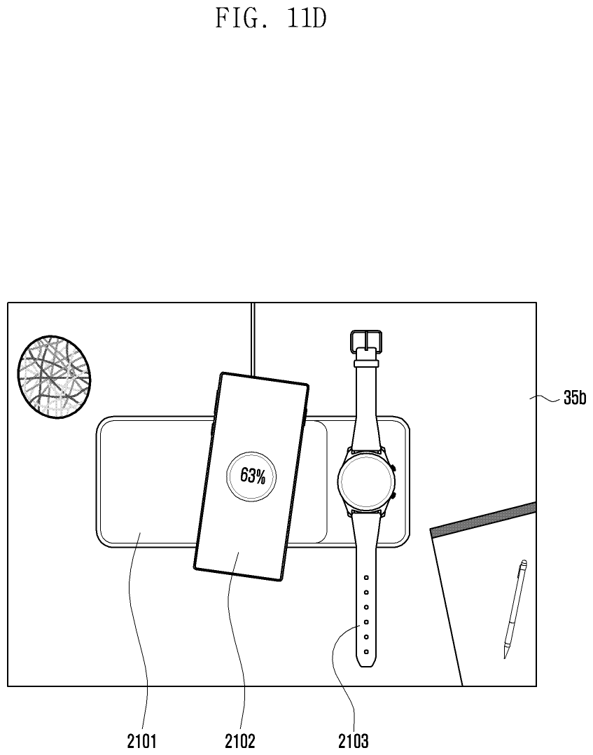

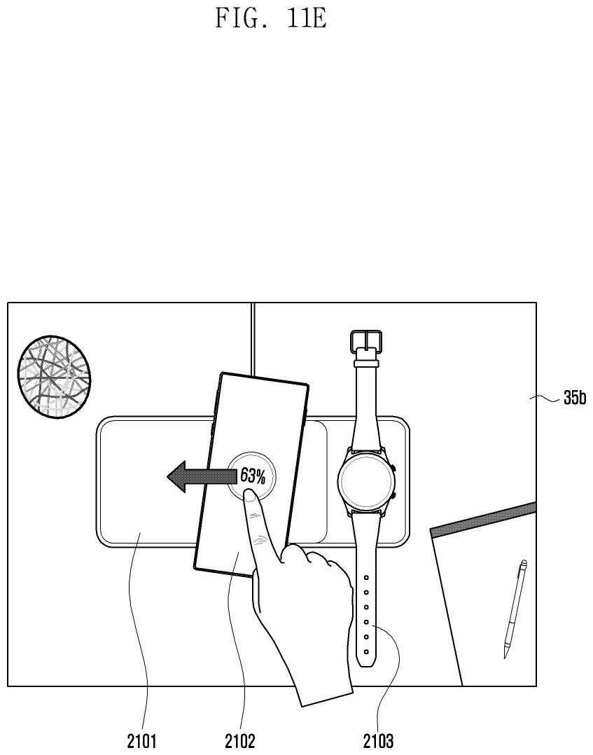

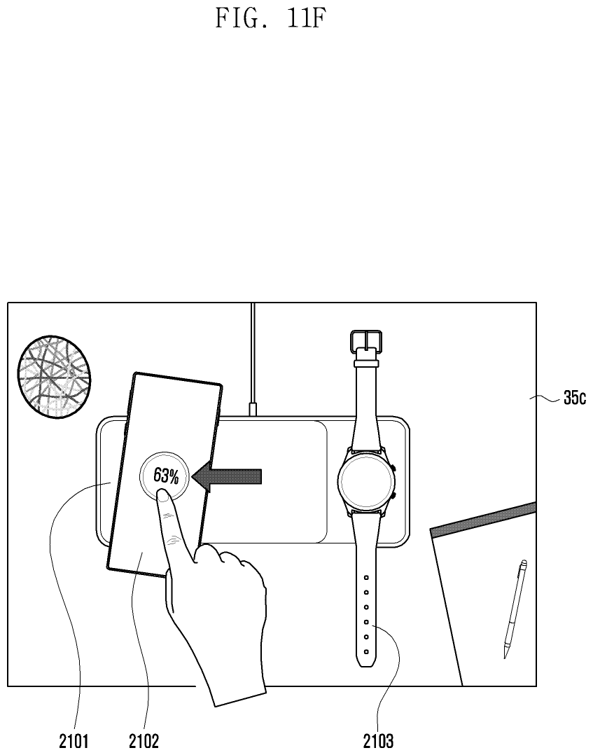

FIGS. 11A, 11B, 11C, 11D, 11E, and 11F are diagrams illustrating an example of adding and moving a plurality of objects according to various embodiments.

Referring to FIG. 11A, the electronic device 101 may display an image 35a (for example, the original image) and receive a user input in the displayed image 35a.

Referring to FIG. 11B, the electronic device 101 may receive an input of a drawing in the image 35a. When it is determined that the input drawing is an input for adding the object, the electronic device 101 may identify an object which the user desires to add based on a shape of the input drawing and information on the identified image. The electronic device 101 may receive an input of a plurality of drawing elements 2001, 2002, and 2003. The electronic device 101 may determine whether the plurality of drawing elements 2001, 2002, and 2003 is included in one object or configures individual objects. For example, the electronic device 101 may determine whether the plurality of drawing elements is a plurality of drawing elements 2001, 2002, and 2003 included in one object or a plurality of drawing elements 2001, 2002, and 2003 configuring individual objects according to colors, locations, and continuity of the input drawings.

Referring to FIG. 11C, the electronic device 101 may generate preliminary object images 2004, 2005, and 2006 for the object. When it is determined that the plurality of drawing elements is a plurality of drawing elements 2001, 2002, and 2003 configuring individual objects (for example, a wireless charger, a smartphone, and a smart watch), the electronic device 101 may generate preliminary object images 2004, 2005, and 2006 including entire shapes of the respective objects.

Referring to FIG. 11D, the electronic device 101 may arrange a plurality of objects 2101, 2102, and 2103 generated based on the plurality of generated preliminary object images 2004, 2005, and 2006 to match the original image and reflect lighting characteristic information to generate a first edited image 35b. Only portions of the plurality of objects 2101, 2102, and 2103 added to the first edited image 35b, rather than the entire shapes thereof, may be displayed according to locations thereof. The electronic device 101 may acquire depth information of the plurality of added objects 2101, 2102, and 2103 from the first edited image 35b.

Referring to FIG. 11E, the electronic device 101 may receive a movement command for the object 2102 (for example, the smartphone) selected from the plurality of objects 2101, 2102, and 2103 and change the location of the selected object 2102 according to the user command as illustrated in FIG. 11F.

The electronic device 101 may calibrate the first object 2101 (for example, the wireless charger) according to movement of the selected object 2102. As an example, a hidden area of the first object 2101 may be changed according to movement of the selected object 2102 on the first object 2101. The electronic device 101 may calibrate the first object 2101, based on the preliminary object image 2004 of the first object 2101 in consideration of the moved location of the selected object 2102. The electronic device 101 may generate a second edited image 35c in which the selected object 2102 moves and the first object 2101 is calibrated. As an example, the electronic device 101 may display the first object 2101 including the hidden part by using the preliminary object image 2004 for the first object 2101 without any separate in-painting process for generating a part of the first object 2101 hidden by the existing location of the second object 2102.

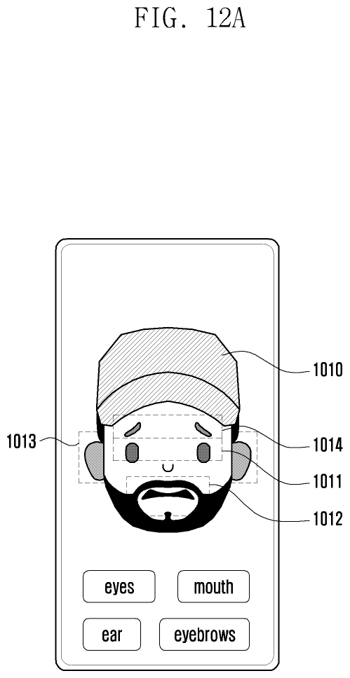

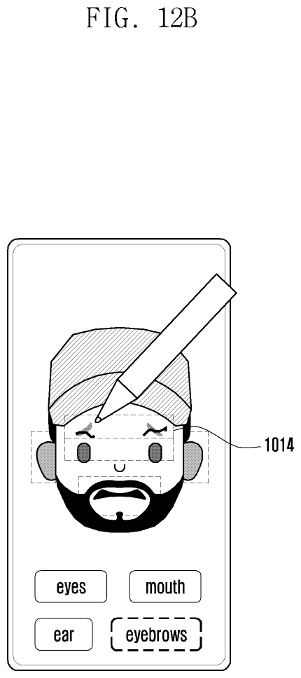

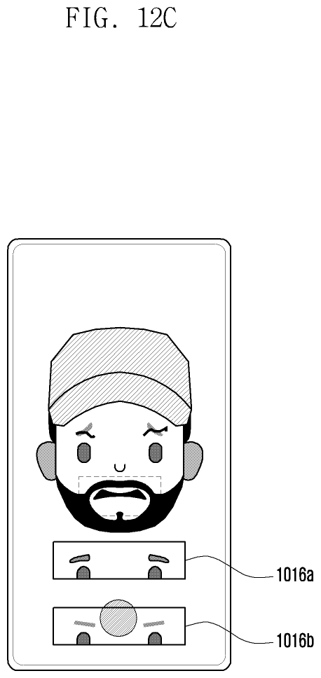

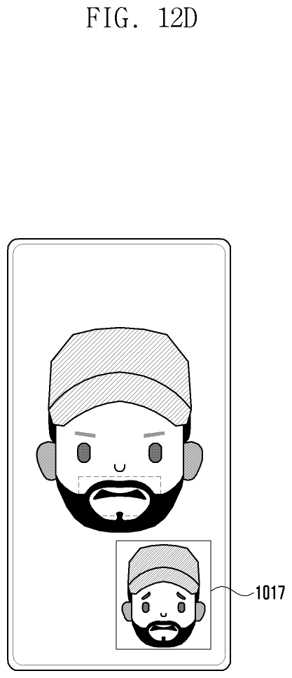

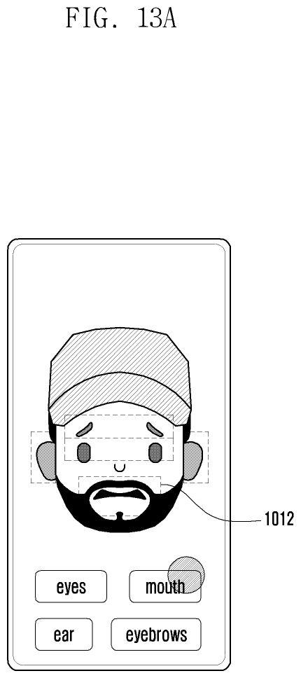

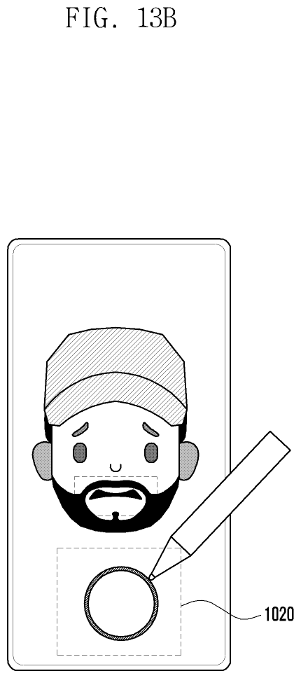

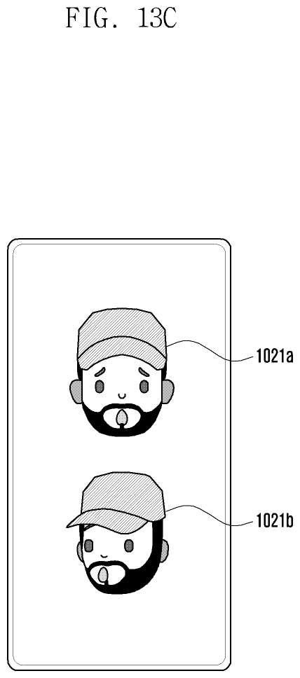

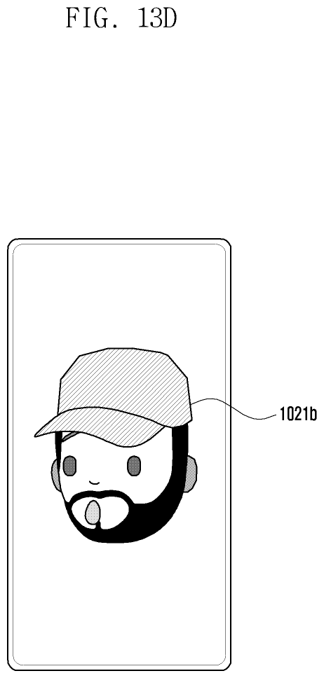

FIGS. 12A, 12B, 12C, 12D, 13A, 13B, 13C, and 13D are diagrams illustrating an example of changing a shape of a partial area of an object according to various embodiments.

Referring to FIG. 12A, as an example, the electronic device 101 may display an image including a face 1010. The electronic device 101 may analyze a main part of the face 1010 and display information on the analyzed main part. For example, the electronic device 101 may analyze an eye part 1011, a mouth part 1012, an ear part 1013, and an eyebrow part 1014 and display the eyes, the mouth, the ears, and the eyebrows.

Referring to FIG. 12B, the user may input a drawing onto one or more parts of the face 1010. As an example, the user may input a drawing for changing the shape of the eyebrows into the eyebrow part 1014. The electronic device 101 may display the input drawing on the face 1010. Further, the electronic device 101 may indicate display information corresponding to the part to which the drawing is input by using highlight or the like.

Referring to FIG. 12C, the electronic device 101 may generate a plurality of images for the part to which the drawing is input, based on the input drawing. The electronic device 101 may generate a plurality of images by using the preliminary object generation model 340 (e.g. preliminary object generation model 340 of FIG. 3). The electronic device 101 may generate a shape of the drawing and the input part as a prompt and input the generated prompt into the preliminary object generation model 340 to generate an image. As an example, the electronic device 101 may generate a prompt of “straight lined eyebrows” and generate a plurality of eyebrow images 1016a and 1016b by using the preliminary object generation model 340. The electronic device 101 may display the plurality of generated eyebrow images 1016a and 1016b on the display 160. The user may select one of the plurality of displayed eyebrow images 1016a and 1016b.

Referring to FIG. 12D, the electronic device 101 may display a completed face to which the second eyebrow image 1016b selected by the user is applied on the display 160. The electronic device 101 may display the original image 1017 together with the edited image.

Referring to FIG. 13A, the electronic device 101 may analyze a main part of the face 1010 and display information on the analyzed main part. For example, the electronic device 101 may analyze an eye part 1011, a mouth part 1012, an ear part 1013, and an eyebrow part 1014 and display the eyes, the mouth, the ears, and the eyebrows. The user may select a part to be edited. As an example, as illustrated in FIG. 13A, the user may select the mouth part 1012.

Referring to FIG. 13B, the electronic device 101 may display an indicator in the selected mouth part 1012 in the face 1010 and display an area 1020 to receive an input of a drawing in one area of the display 160. When the user inputs a drawing in a shape of “O”, the electronic device 101 may generate a prompt, based on the shape of the input drawing. For example, the electronic device 101 may generate a prompt of “mouth shape like letter O” and input the prompt to the preliminary object generation model 340.

Referring to FIG. 13C, the preliminary object generation model 340 may generate a plurality of face images 1021a and 1021b in which the mouth shape is edited based on the input prompt. The electronic device 101 may display the plurality of generated face images 1021a and 1021b on the display 160. The user may select one face image from among the plurality of face images 1021a and 1021b. For example, the user may select the second face image 1021b.

Referring to FIG. 13D, the electronic device 101 may display the selected second face image 1021b as an edited image.

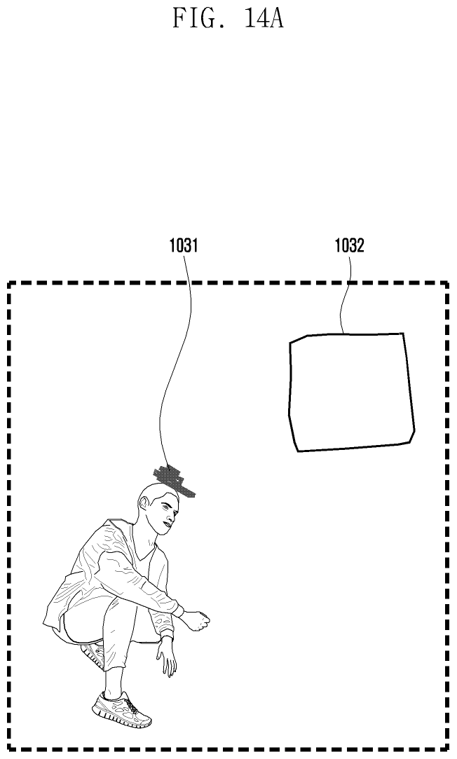

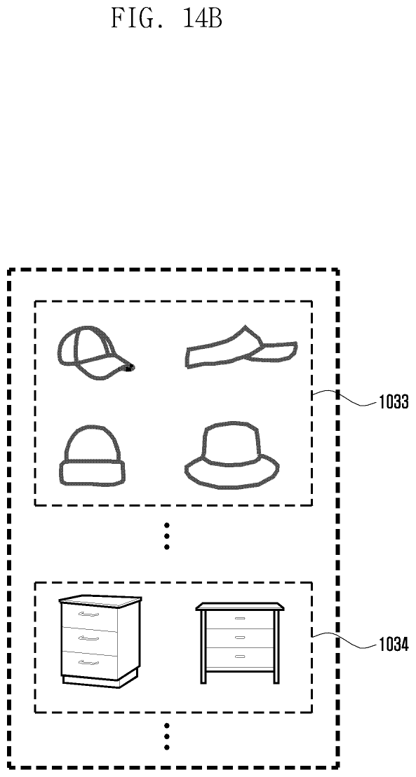

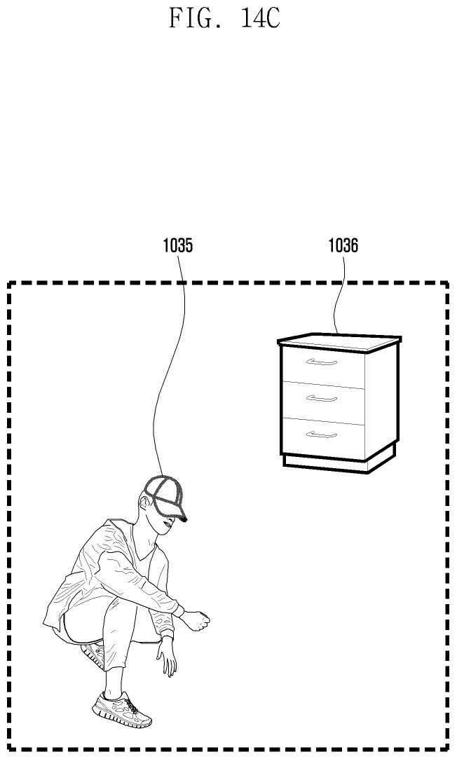

FIGS. 14A, 14B, and 14C are diagrams illustrating an example of adding an object by using other information according to various embodiments.

Referring to FIG. 14A, an indoor image including a person is illustrated. The user may input a green drawing 1031 into a persons' head area and input a brown rectangle drawing 1032 into one area. The electronic device 101 may determine attributes of the drawing, based on information on the image, information on the object, a shape of the input drawing, a color of the drawing, a drawing area, and/or the relationship between the drawing and the object. For example, the electronic device 101 may determine an object of the green drawing 1031 input into the person's head area as a green hat and determine an object of the brown rectangle drawing 1032 input into one area as brown furniture. The electronic device 101 may generate preliminary object images, based on the determined attributes of the drawings.

Referring to FIG. 14B, the electronic device 101 may generate preliminary object images by using another image. For example, the electronic device 101 may extract an object having attributes which are the same as those of the determined drawing in an image searched in a web, an image of a storage space (for example, memory, cloud server, or the like) connected to a user account, an image related to a shopping list, and/or an image related to a list of interest. As an example, the electronic device 101 may extract a plurality of green hats 1033 and a plurality of pieces of brown furniture 1034 and display the same on the display 160. The user may select one of the plurality of displayed green hats 1033 and select one of the pieces of the plurality of brown furniture 1034.

Referring to FIG. 14C, the electronic device 101 may add the green hat 1035 selected by the user to the part (for example, the person's head part) into which the green drawing is input and add the brown furniture 1036 selected by the user to the part (for example, the one area) into which the brown drawing is input. The electronic device 101 may generate and display an edited image (for example, first edited image) to which the object is added.

For example, the original image captured at wide angle reflects a view angle corresponding thereto, and when the corresponding object moves to another location within the image and the existing view angle is maintained, an awkward image different from the real situation may be generated according to a characteristic of the original image and a characteristic of the object shape. When generating a preliminary image of the separated and extracted object (for example, furniture), the electronic device 101 may analyze a space within the original image to additionally generate a preliminary object image of the object to match another view angle. As an example, when the generated object moves to another location, if it is determined that the view angle of the object at the moved location is not realistic through the image analysis model, the electronic device 101 may additionally generate a preliminary object image to make the moved object shown at the realistic view angle.

Further, the electronic device 101 may be implemented as an augmented reality (AR), a virtual reality (VR), or a mixed reality (MR) device. The electronic device 101 implemented as the AR, the VR, or the MR device may provide a simulation function of changing and showing a color and/or texture of the object from the user's point of view. The electronic device 101 may capture the image at a specific time point and divide the image (or group objects) to allow the user to select the object. For example, the electronic device 101 may receive a user input (for example, a 2D or a 3D drawing) of adding the object to the two-dimensional (2D) original image or the three-dimensional (3D) original image in a virtual space and generate a preliminary object image for the added object and/or the existing object as 3D image information. For example, when the user moves in the virtual space or moves the object in the virtual object, the electronic device 101 may provide a virtual space reflecting movement of the user or the object by using the preliminary object image generated as the 3D image information.

For example, the electronic device 101 may display, in a thumbnail form, a product which is the same as/similar to the object selected by the user from a shopping list through a link with online shopping. According to an embodiment, the electronic device 101 may display a UI for selecting a color and/or texture in the 3D space. When the user selects a specific color and/or texture displayed in the UI and drags and moves the same to the location of the object, the electronic device 101 may generate an image of the object to which the selected color and/or texture are applied. The electronic device 101 may display a 3D modeling result of the object to which the selected color and/or texture are applied using the image editing model.

When a time point viewed at which a wearer views is similar to a time point at which a task is requested, the electronic device 101 may adjust and display transparency of the generated result. As an example, when the time point at which the wears views is different from the time point at which the task is requested, the electronic device 101 may display a message indicating that the task requested by the user has been completed in one area of the screen.

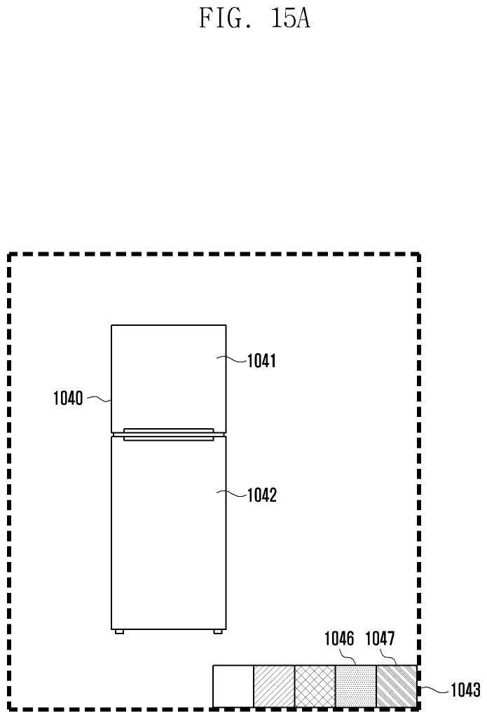

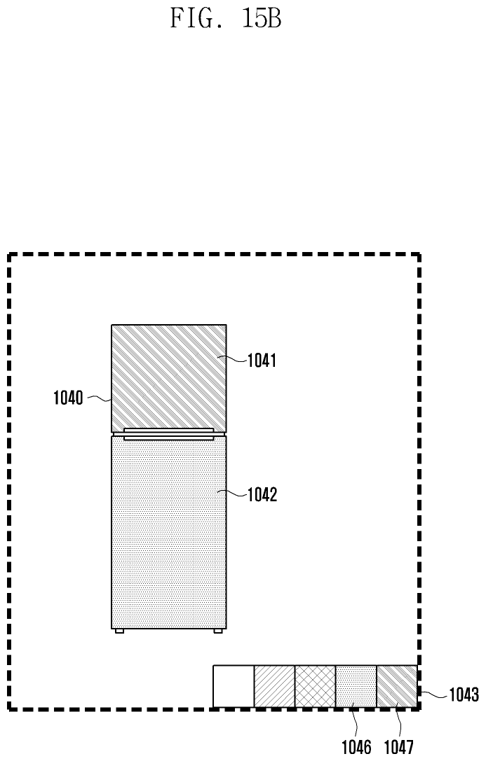

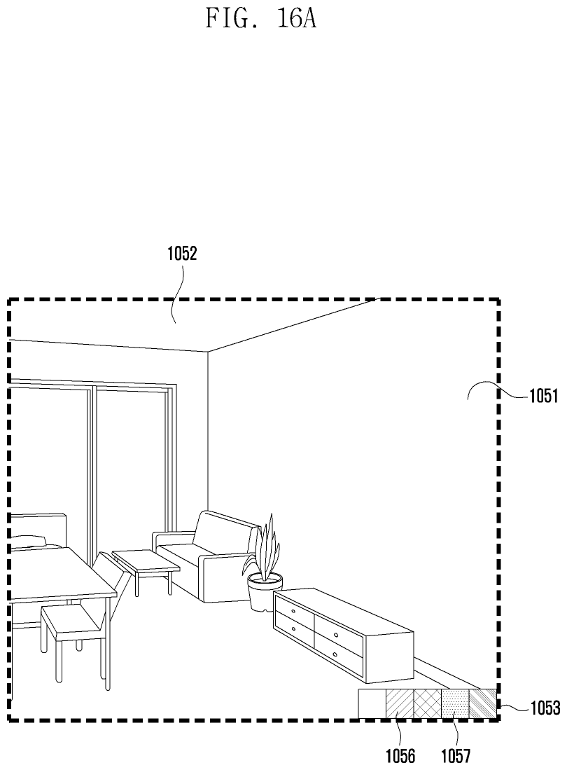

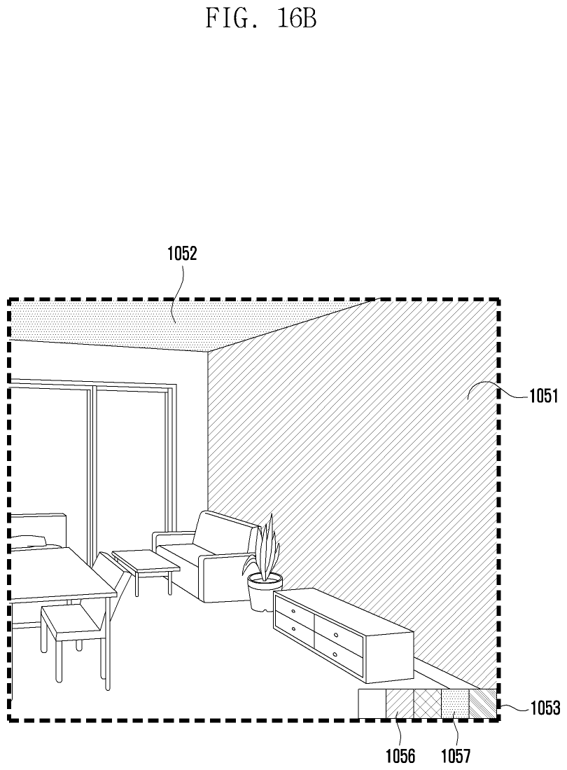

FIGS. 15A, 15B, 16A, and 16B are diagrams illustrating an example of changing a color of an area within an image according to various embodiments.

Referring to FIG. 15A, an image including a refrigerator 1040 as an object (for example, a subject) is illustrated. The user may color sides of the refrigerator. When an editing operation for the image is performed, the electronic device may provide a color palette in a UI form. The user may select a color and draw a user input into the image by using a finger or a pen. For example, the electronic device 101 may display a UI 1043 including types of colors to color and color the color selected by the user in the area into which the drawing is input. For example, the user may input a drawing for coloring an upper side 1041 of the refrigerator 1040 with a second color 1047 and input a drawing for coloring a lower side 1042 of the refrigerator 1040 with a first color 1046. The electronic device 101 may analyze an image area (for example, the upper side 1041 or the lower side 1042) including the drawing and determine an area to color. Further, the electronic device 101 may color the determined area with the determined color (for example, the first color 1047 or the second color 1046).

Referring to FIG. 15B, the refrigerator 1040 having the upper side 1041 colored with the second color 1047 and the lower side 1042 colored with the first color 1046 is illustrated. The electronic device 101 may identify an entire shape of the colored object (for example, refrigerator 1040) and generate a preliminary object image. The electronic device 101 may provide the generated preliminary object image to make the preliminary object image editable. If the refrigerator 1040 moves to another area, the electronic device 101 may generate a background area in which the refrigerator 1040 was located. The generating of the background area may be, for example, filling an empty space with a color which is the same as that of surrounding spaces. For example, the electronic device 101 may generate a preliminary object image for the background as well as the preliminary object image for the specific object (for example, the refrigerator 1040). The preliminary object image for the background may include image information for the generated background. When the refrigerator 1040 moves within the image, the generated may not be separately performed, and an edited image may be provided using the preliminary object image for the background.

Referring to FIG. 16A, an indoor image is illustrated. The user may color a wall. For example, the electronic device 101 may display a UI 1053 including types of colors to color and color an area into which a drawing is input with a color selected by the user. For example, the user may input a drawing for coloring a lateral side 1051 with a first color 1056 and input a drawing for coloring ceiling 1052 with a second color 1057. The electronic device 101 may analyze an image area (for example, the lateral side 1051 or the ceiling 1052) including the drawing and determine an area to color. Further, the electronic device 101 may color the determined area with the determined color (for example, the first color 1056 or the second color 1057).

Referring to FIG. 16B, an indoor image including the lateral side 1051 colored with the first color 1056 and the ceiling 1052 colored with the second color 1057 is illustrated. If another object moves and thus hidden areas of the lateral side 1051 and/or the ceiling 1052 are exposed, the electronic device 101 may generate a background area (for example, the hidden area) in which the other object was located using a preliminary image object generated for the background.

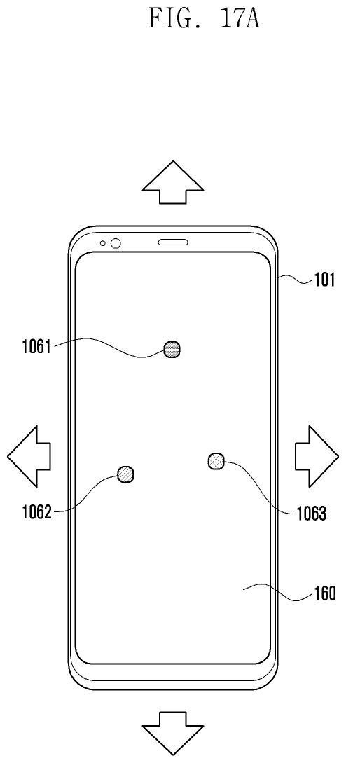

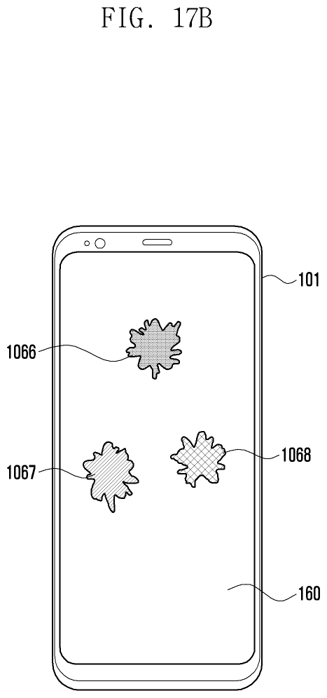

FIGS. 17A and 17B are diagrams illustrating an example of editing an image by motion of an electronic device according to various embodiments.

Referring to FIG. 17A, an electronic device 101 receiving an input of colors 1061, 1062, and 1063 in different colors from the user is illustrated. The electronic device 101 may receive the objects colors 1061, 1062, and 1063 in specific colors by the display 160 through a user input. The electronic device 101 may generate a new object, based on a figure drawn by a user input. Accordingly, the electronic device 101 may generate an image, based on a figure including simple dots and lines. The electronic device 101 may provide a random art effect through a sensor (for example, the sensor module 176 of FIG. 1). For example, the electronic device 101 may detect shaking of the electronic device 101 through the sensor and provide various effects, based on the detected shaking. For example, the sensor may include a gravity sensor, an acceleration sensor, a gyro sensor, and/or a geomagnetic sensor.

Referring to FIG. 17B, the electronic device 101 may provide color-running effects 1066, 1067, and 1068 around the input color areas, based on a direction and a speed of movement of the electronic device 101 detected through the sensor. The electronic device 101 may identify a coloring drawing input for the color-running area and generate a preliminary object image, based on the identified coloring drawing input. For example, the electronic device 101 may determine that the drawing input through the sensor (for example, the sensor module 176 of FIG. 1) is an input of modifying the object or the background included in the original image.

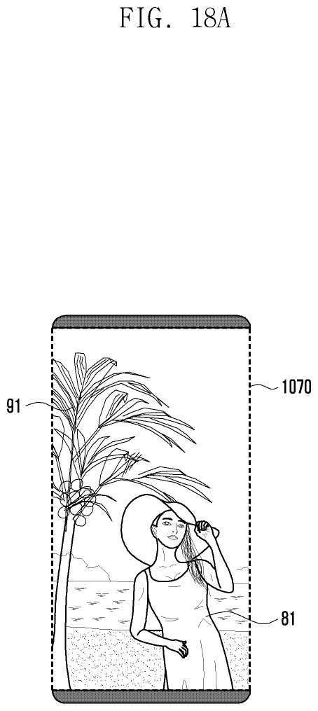

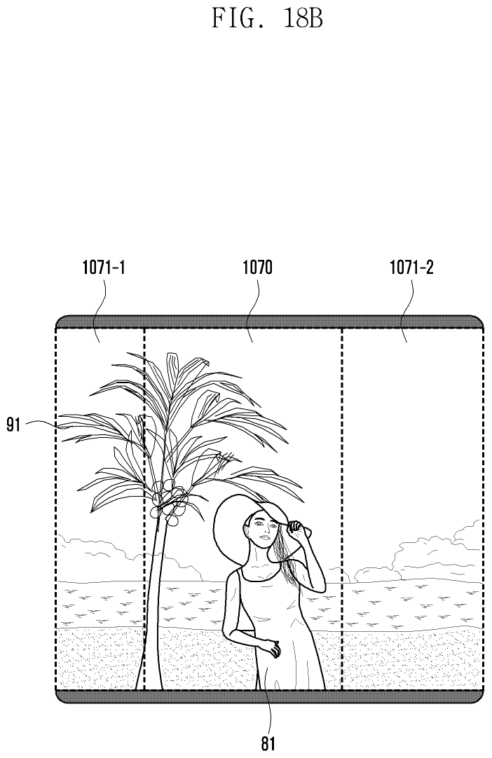

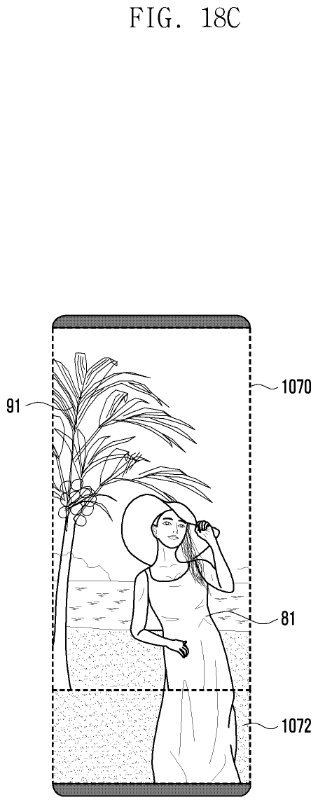

FIGS. 18A, 18B, and 18C are diagrams illustrating an example of displaying images in various sizes by using a preliminary object image according to various embodiments.

Referring to FIG. 18A, a first display area 1070 for displaying a plurality of objects generated based on a preliminary object image is illustrated. The electronic device 101 may display an image including at least a part of the preliminary object image on the display area 1070 in various sizes and/or forms. For example, the electronic device 101 may include a rollable display or a foldable display. In the case of the rollable display, the physical size of the display may be changed in real time. As described above, the electronic device 101 may generate a preliminary object image for an object (including a background) included in the image. Accordingly, although the size of the display is changed, the electronic device 101 may display an image corresponding to the size of the display in real time.

Since the generated preliminary object image includes entire parts as well as a part shown on the display 160, the image may be displayed in real time to fit the changed size of the screen of the rollable form factor. For example, when generating the preliminary object image, the electronic device 101 may generate a prompt for generating the preliminary object image having the maximum resolution and size of the image which can be displayed based on the type of the form factor (for example, rollable or foldable), and input the generated prompt into the preliminary object generation model. For example, the prompt may include information of “Create the image at a resolution of 2272×1984, and perform out-painting on the extension area at the bottom”.

As illustrated in FIG. 18A, as an example, the electronic device 101 may generate preliminary object images for a person 81 and a tree 91 and display a part (for example, a first part) of the person 81 and a part (for example, a first part) of the tree 91 according to an area (or size) 1070 of a current first display. However, although not displayed on the display of FIG. 18A, the preliminary object image of the person 81 may include another part (for example, a second part) and the preliminary object image of the tree 91 may include another part (for example, a second part).

Referring to FIG. 18B, the display area of the electronic device 101 may extend in a left and right direction. For example, the display 160 may be a rollable display or a foldable display. The display area may extend to an area including a second display area 1071-1 in a left direction of the first display area 1070 and a third display area 1071-2 in a right direction. The electronic device 101 may display, in the second display area 1071-1 and the third display area 1072-2, image parts which were not previously displayed, by using preliminary object images generated according to extension of the display area. For example, the electronic device 101 may display, in the second display area 1071-1, the second part of the tree 91 which is not displayed in the first display area 1070.

Referring to FIG. 18C, the display area of the electronic device 101 may extend in a downward direction. The display area may extend to an area including a fourth display area 1072 in a downward direction of the existing first display area 1070. The electronic device 101 may display, in the fourth display area 1072, an image part which was not previously displayed, by using a preliminary object image generated according to extension of the display area. For example, the electronic device 101 may display, in the fourth display area 1072, the second part of the person 81 which is not displayed in the first display area 1070.

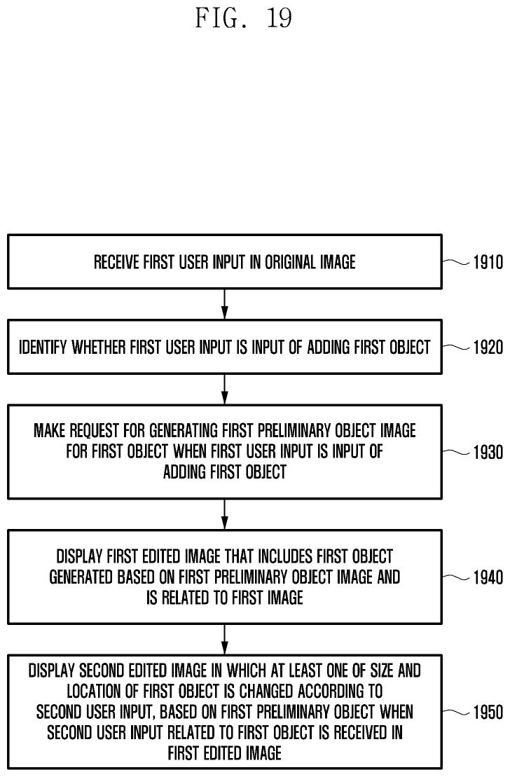

FIG. 19 is a flowchart illustrating an image editing method according to various embodiments.

In the following embodiments, respective operations may be sequentially performed but the sequential performance is not necessary. For example, orders of the respective operations may be changed, and at least two operations may be performed in parallel.

According to an embodiment, it may be understood that operations 1910 to 1950 are performed by a processor (for example, the processor 120 of FIG. 2) of an electronic device (for example, the electronic device 101 of FIG. 2).

Referring to FIG. 19, the electronic device 101 may receive a first user input in a displayed original image (for example, the original image 11 of FIG. 5) in operation 1910. The electronic device 101 may identify a first object, based on a shape drawn by the first user input and identify whether the first user input is an input of adding a first object in operation 1920. For example, the user input may be an input of adding the object, an input of modifying the object, or a control input. The input of adding the object may include an input of adding a new thing and/or person. The input of modifying the object may include an input of changing the size or shape of the object, an input of changing a color, and/or an input of adding a color. The control input corresponds to a command related to image editing and may include an input of changing a location of the object and/or an input of adding information on the object. That is, the electronic device 101 may identify whether the user input is an input of adding the object, the input of modifying the object, or the control input.

When the first user input is the input of adding the first object, the electronic device 101 may make a request for generating a first preliminary object image (for example, the preliminary object image 25a of FIG. 5) including attributes of the first object in operation 1930. As an example, the electronic device 101 may make a request for generating a second preliminary object image (for example, the preliminary object image 27a of FIG. 5) including attributes of a second object. For example, the first object may be an added object, and the second object may be an object included in the original image. For example, the electronic device 101 may make a request for generating a preliminary object image to an artificial intelligence-based computing device. The artificial intelligence-based computing device is included in the electronic device 101, and the processor 120 may make a request for generating a preliminary object image to the artificial intelligence-based computing device. As an example, the artificial intelligence-based computing device may be included in an external device (for example, the server 108 of FIG. 1). The electronic device 101 may make a request for generating a preliminary object image to the artificial intelligence-based computing device through a communication interface (for example, the communication module 190 of FIG. 1).

The electronic device 101 may generate a first edited image (for example, the first edited image 12 of FIG. 5), based on the first preliminary object image. The first edited image may include a part (for example, a first part) of the first object (for example, the object 25b of FIG. 5) and may be an image related to the original image. As an example, the first edited image may include a part (for example, a first part) of the second object (for example, the object 27b of FIG. 5). The electronic device 101 may display the first edited image in operation 1940.

When receiving a second user input related to the first object in the first edited image, the electronic device 101 may display a second edited image (for example, the second edited image 13 of FIG. 5) in which the size and/or the location of the first object are changed according to the second user input, based on the first preliminary object image in operation 1950. For example, the input related to the first input in the first edited image may be an input of moving the first object. For example, the input of moving the first object may be an input (for example, a drag input) of moving the first object to another location in the screen in the state where the first object is selected, or a control input. As an example, the control input may be an input in an arrow shape corresponding to a distance and a direction of movement of the first object. As an example, when receiving the input of moving the first object in the first edited image, the electronic device 101 may display the second edited image in which the location of the first object is changed, based on the first preliminary object image. The electronic device 101 may acquire depth information of the first object, based on the change in the location of the first object and display the first object, based on the acquired depth information of the first object. Further, the electronic device 101 may automatically change the location of the second object in the second edited image to a location different from the location of the second object in the first edited image, based on the relationship with the first object.

As an example, a method of editing the image may receive the first user input in a first image (for example, the original image 11 of FIG. 5). The method may identify whether the first user input is an input of adding the first object (for example, the object 25b of FIG. 5). When the first user input is the input of adding the first object, the method may make a request for generating the first preliminary object image (for example, the preliminary object image 25a of FIG. 5) for the first object. The method may display a second image (for example, the first edited image 12 of FIG. 5) that includes a first object generated based on the preliminary object image and is related to the first image. When a second user input related to the first object is received in the second image, the method may display a third image (for example, the second edited image 13 of FIG. 5) in which the second part of the first object is added to the second image, based on the first object image information.

As an example, the operation of identifying whether the first user input is the input of adding the first object, the method may identify the first object, based on a shape drawn by the first user input.

As an example, the first preliminary object image may be generated based on image information of an object which is included in another image and is a type equal to the first object.

As an example, the first preliminary object image may include a first part and a second part of the first object. The operation of displaying the second image may display only the first part of the first object. The operation of displaying the third image may display the first part and the second part of the first object.

As an example, the operation of displaying the third image may display a lighting effect, based on a change in at least one of the size and the location of the first object.

As an example, the method may identify a second object (for example, the object 27b of FIG. 5) included in the first image and make a request for generating a second preliminary object image (for example, the preliminary object image 27a of FIG. 5) for the second object. The second preliminary object image may include a first part and a second part of the second object. The operation of displaying the second image may display the second object generated based on the second preliminary object image.

As an example, when the location of the first object is changed to be behind the second object, the operation of displaying the third image may acquire depth information of the first object larger than depth information of the second object. When the location of the first object is changed to be in front of the second object, the operation of displaying the third image may acquire depth information of the first object smaller than depth information of the second object. The operation of displaying the third image may display the first object and the second object, based on the depth information of the first object and the depth information of the second object.

As an example, when the location of the first object is changed to a location overlapping an area in which the second object is located, the operation of displaying the third image may display only the first part of the second object except for the second part of the second object overlapping the first object when depth information of the first object is smaller than depth information of the second object. The operation of displaying the third image may display only the first part of the first object except for the second part of the first object overlapping the second object when the depth information of the first object is larger than the depth information of the second object

As an example, the first image may include the first part and the second part of the second object. The operation of displaying the third image may display the first part of the second object and the first part of the second part, based on relationship with the first object.

As an example, the first image may include the second object in a first size. The operation of displaying the second image may display the second object in a second size different from the first size, based on relationship with the first object.

As an example, the operation of identifying the first user input may identify the first user input, based on a type of an input scheme of the first user input.

As an example, the electronic device 101 may include the display 160, at least one processor 120, and the memory 130 configured to store instructions executed by the at least one processor 120. The instructions may cause the electronic device 101 to, when a first user input of adding a first object is received in a first image displayed on the display 160, make a request for generating first object image information including a first part and a second part of the first object. The instructions may cause the electronic device 101 to display a second image in which the first part between the first part and the second part of the first object is added to the first image on the display 160, based on the first object image information. The instructions may cause the electronic device 101 to, when a second user input related to the first object is received in the second image, display a third image in which the second part of the first object is added to the second image, based on the first object image information.

As an example, the instructions may cause the electronic device 101 to identify, through an artificial intelligence computing device, attributes of the first object including a type or a characteristic of the first object, based on a shape configured by the first user input.

As an example, the instructions may cause the electronic device 101 to identify relevance between the attributes of the first object and environment information of the first image. The first object image information may include information on a new object related to the first object, based on the relevance.

As an example, background information of the first image may include at least one piece of place information, time information, and weather information.

As an example, the instructions may cause the electronic device 101 to display a plurality of objects which is included in at least one of the image stored in the memory 130 and a searched image and is a type equal to the first object. The instructions may cause the electronic device 101 to generate the first object image information, based on an image of one object selected from among the plurality of displayed objects.

As an example, the instructions may cause the electronic device 101 to select a second object from among a plurality of objects included in the first image according to a preset priority. The instructions may cause the electronic device 101 to make a request for generating second object image information including a first part and a second part of the selected second object.

As an example, the instructions may cause the electronic device 101 to automatically change a location of a second object in the third image to a location different from the location of the second object in the second image, based on relevance with the first object.

As an example, a non-transitory computer-readable storage medium recording programs that perform a method of editing an image may, when a first touch gesture input is received in a first image through a touch screen, identify whether the first touch gesture input is an input of adding a first object in the first image or an input of modifying a second object included in the first image. The non-transitory computer-readable storage medium may, when the first touch gesture input is the input of adding the first object, make a request for generating first object image information including a first part and a second part of the first object to an artificial intelligence computing device. The non-transitory computer-readable storage medium may display at least one of the first part and the second part of the first object in the first image, based on the first object image information. The non-transitory computer-readable storage medium may, when the first gesture input is the input of modifying the second object, make a request for generating second object image information including a third part and a fourth part of the second object to the artificial intelligence computing device. The non-transitory computer-readable storage medium may display at least one of the third part and the fourth part of the second object in the first image, based on the second object image information.

As an example, the input of modifying the second object included in the first image may include an input for changing at least one of a color and texture for at least a portion of the second object.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it denotes that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Effects of the disclosure are not limited to the above-mentioned effects, and other effects that have not been mentioned above can be clearly understood from the above description by those skilled in the art.

1. A method of editing an image, the method comprising:
receiving a first user input for a first image;
determining whether the first user input indicates an instruction to add a first object;
when the first user input indicates the instruction to add the first object, generating a first preliminary object image for the first object;
displaying a second image including the first object, the second image being generated based on the first preliminary object image and being associated with the first image; and
when a second user input indicating an instruction to alter the first object is received for the second image, displaying a third image in which at least one of a size or a location of the first object is changed according to the second user input.

2. The method of claim 1, wherein the determining whether the first user input indicates the instruction to add the first object comprises identifying the first object, based on a drawn shape in the first user input.

3. The method of claim 1, wherein the first preliminary object image is generated based on image information of an object which is included in another image and is an image type similar to the first object.

4. The method of claim 1, wherein:
the first preliminary object image comprises a first part of the first object and a second part of the first object;
the displaying the second image comprises displaying the first part of the first object and abstaining from displaying the second part of the first object; and
the displaying the third image comprises displaying the first part of the first object and the second part of the first object.

5. The method of claim 1, wherein the displaying the third image comprises displaying a lighting effect based on a change in at least one of the size or the location of the first object.

6. The method of claim 4, further comprising identifying a second object included in the first image and generating a second preliminary object image for the second object,
wherein the second preliminary object image comprises a first part of the second object and a second part of the second object, and
the displaying the second image further comprises displaying the second object generated based on the second preliminary object image.

7. The method of claim 6, wherein the displaying the third image comprises:
when the location of the first object is changed to be behind the second object, acquiring depth information of the first object that is larger than depth information of the second object and,
when the location of the first object is changed to be in front of the second object, acquiring depth information of the first object that is smaller than depth information of the second object; and
displaying the first object and the second object based on the depth information of the first object and the depth information of the second object.

8. The method of claim 6, wherein the displaying the third image comprises, when the location of the first object is changed to a location overlapping an area in which the second object is located:
displaying the first part of the second object and abstaining from displaying the second part of the second object overlapping the first object when depth information of the first object is smaller than depth information of the second object; and
displaying the first part of the first object and abstaining from displaying the second part of the first object overlapping the second object when the depth information of the first object is larger than the depth information of the second object.

9. The method of claim 6, wherein:
the first image comprises the first part of the second object and the second part of the second object; and
the displaying the third image comprises displaying the first part of the second object, based on a relationship between the second object and the first object, without displaying the second part of the second object.

10. The method of claim 6, wherein:
the first image comprises the second object having a first size; and
the displaying the second image comprises displaying the second object having a second size different from the first size based on a relationship between the second object and the first object.

11. The method of claim 1, wherein the determining whether the first user input indicates the instruction to add the first object comprises determining the first user input based on a type of an input scheme of the first user input.

12. An electronic device comprising:
a display;
at least one processor; and
a memory configured to store instructions executed by the at least one processor,
wherein the instructions cause the electronic device to:
when a first user input indicating instruction to add a first object is received for a first image displayed on the display, generating a first object image information that comprises a first part of the first object and a second part of the first object;
display, on the display, a second image in which the first part of the first object is added to the first image without adding the second part of the first object to the first image, based on the first object image information; and
when a second user input indicating an instruction to alter the first object is received for the second image, display a third image in which the second part of the first object is added to the second image.

13. The electronic device of claim 12, wherein the instructions further cause the electronic device to identify, through an artificial intelligence computing device, attributes of the first object comprising a type or a characteristic of the first object based on a shape configured by the first user input.

14. The electronic device of claim 13, wherein:
the instructions further cause the electronic device to determine relevance between the attributes of the first object and environment information of the first image, and
the first object image information comprises information on a new object related to the first object based on the relevance.

15. The electronic device of claim 14, wherein the environment information of the first image comprises at least one piece of place information, time information, or weather information.
